(19) United States
(12) Patent Application Publication
(10) Pub. No.: US 2016/0335547 A1
(43) Pub. Date: Nov. 17, 2016

(54) INFORMATION PROCESSING DEVICE, METHOD, AND COMPUTER READABLE MEDIUM

(71) Applicant: FUJITSU LIMITED, Kawasaki-shi (JP)

(72) Inventor: Eiji HASEGAWA, Kawasaki (JP)

(73) Assignee: FUJITSU LIMITED, Kawasaki-shi (JP)

(21) Appl. No.: 15/089,659

(22) Filed: Apr. 4, 2016

(30) Foreign Application Priority Data
May 11, 2015 (JP) 2015-096739

(51) Int. Cl. G06N 5/04

(52) U.S. Cl. CPC G06N 5/04

(57) ABSTRACT

An information processing device includes a processor configured to: acquire information of first status that represents a state of a first detection target; specify state transition in which the first status is changed based on the acquired information of the first status; acquire information of second status that represents a state of a second detection target; specify state transition in which the second status is changed based on the acquired information of the second status; specify a time point earlier than a first time point at which the state transition of the second status is specified as a second time point at which the state transition of the second status occurs; determine whether a combination of the second status and the first status at least at the second time point satisfies a predetermined condition; and perform predetermined processing according to a determination result indicating the condition is satisfied.

### CROSS-REFERENCE TO RELATED APPLICATION

This application is based upon and claims the benefit of priority of the prior Japanese Patent Application No. 2015-096739, filed on May 11, 2015, the entire contents of which are incorporated herein by reference.

### FIELD

The embodiments discussed herein are related to a technique for monitoring a state.

### BACKGROUND

There is an application that performs predetermined processing such as measurement of momentum, for example, in a case where a walking state of a user is detected by a portable terminal. The detection of the walking state is performed by a walking sensor that logically detects the walking state by using a physical sensor that measures acceleration.

The walking sensor logically detects the walking state by specifying periodicity relating to change in acceleration. Accordingly, the walking sensor performs determination with respect to time-series data with a certain length.

A logic sensor performing determination on the premise of obtaining the time-series data with a certain length detects a state later than when state transition actually occurs.

Accordingly, one logic sensor is sufficient to detect state transition of one item of status, in many cases.

As examples of the related art, Japanese Laid-open Patent Publication No. 2010-16444, Japanese Laid-open Patent Publication No. 2010-74278, Japanese Laid-open Patent Publication No. 2011-228872, and International Publication Pamphlet No. WO 2011/114620 are known.

### SUMMARY

According to an aspect of the invention, an information processing device includes a processor configured to: acquire information of first status that represents a state of a first detection target; specify state transition in which the first status is changed based on the acquired information of the first status; acquire information of second status that represents a state of a second detection target; specify state transition in which the second status is changed based on the acquired information of the second status; specify a time point earlier than a first time point at which the state transition of the second status is specified as a second time point at which the state transition of the second status occurs; determine whether a combination of the second status and the first status at least at the second time point satisfies a predetermined condition; and perform predetermined processing according to a determination result indicating the condition is satisfied.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an embodiment of an usage of a portable terminal;

FIG. 2 illustrates an example of status transition;

FIG. 3 illustrates an example of the status transition;

FIG. 4 illustrates an example of table transition;

FIG. 5 illustrates an example of a hardware configuration of the portable terminal;

FIG. 6 illustrates an example of a module configuration of the portable terminal;

FIG. 7 illustrates an example of a first detection processing flow;

FIG. 8 illustrates an example of a measurement processing flow;

FIG. 9 illustrates a second detection processing (A) flow;

FIG. 10 illustrates an example of a first window;

FIG. 11 illustrates an example of a second window;

FIG. 12 illustrates an example of a first specification processing flow;

FIG. 13 illustrates an example of a second specification processing flow;

FIG. 14 illustrates an example of a monitoring processing (A) flow;

FIG. 15 illustrates an embodiment of the usage of the portable terminal;

FIG. 16 illustrates an example of the status transition;

FIG. 17 illustrates an example of the status transition;

FIG. 18 illustrates an example of the table transition;

FIG. 19 illustrates an embodiment of the usage of the portable terminal;

FIG. 20 illustrates an example of the status transition;

FIG. 21 illustrates an example of the table transition;

FIG. 22A illustrates a monitoring processing (B) flow;

FIG. 22B illustrates a monitoring processing (B) flow;

FIG. 23 illustrates an example of a hardware configuration of the portable terminal;

FIG. 24 illustrates an example of a hardware configuration of a microcontroller;

FIG. 25 illustrates an example of a hardware configuration of the portable terminal;

FIG. 26 illustrates an example of the hardware configuration of the microcontroller;

FIG. 27 illustrates a first example of program allocation;

FIG. 28 illustrates a second example of the program allocation;

FIG. 29 illustrates a third example of the program allocation;

FIG. 30 illustrates an example of a configuration of a state monitoring system;

FIG. 31 illustrates a first example of module arrangement;

FIG. 32 illustrates a second example of the module arrangement;

FIG. 33 illustrates a third example of the module arrangement;

FIG. 34 illustrates an example of a configuration of the state monitoring system;

FIG. 35 illustrates a fourth example of the module arrangement;

FIG. 36 illustrates a fifth example of the module arrangement;

FIG. 37 illustrates a sixth example of the module arrangement;

FIG. 38 illustrates an example of table transition;

FIG. 39 illustrates an example of a second detection processing (B) flow;

FIG. 40 illustrates an example of a monitoring processing (C) flow; and

FIG. 41 is a functional block diagram of a computer.

### DESCRIPTION OF EMBODIMENTS

An aspect of an exemplary embodiment aims to more properly capture a state according to a combination of a plurality of status.

### First Embodiment

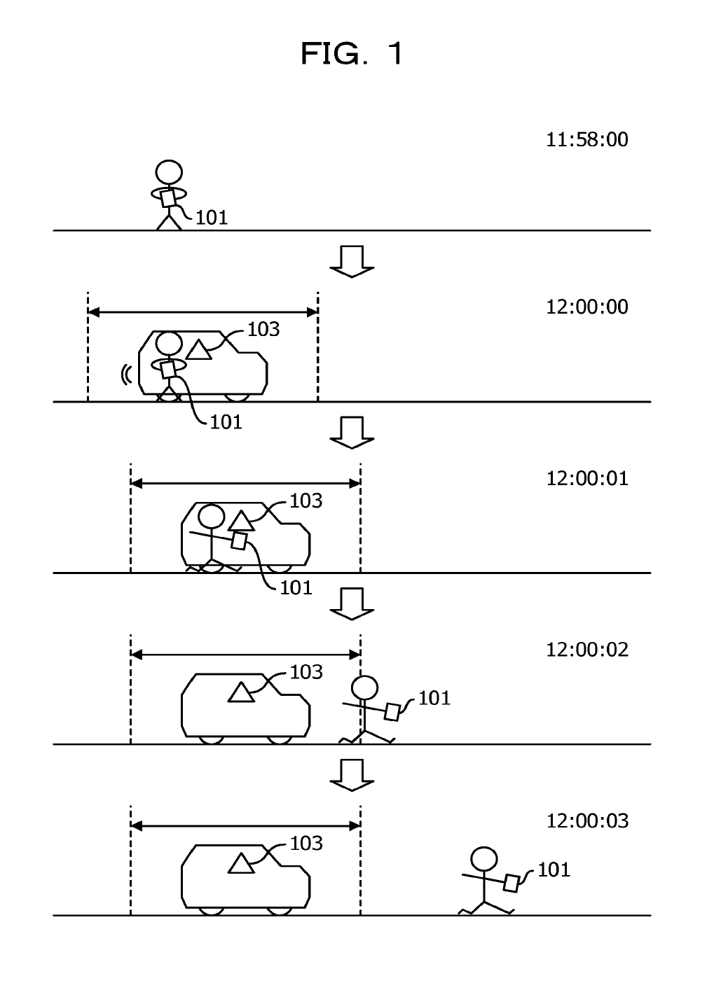

FIG. 1 illustrates an embodiment of a usage of a portable terminal 101. An application in this example informs a user that there is a taxi present in the vicinity of the user who is walking. The portable terminal 101 in which the application is operated has a function of detecting a wireless tag 103 mounted on the taxi, a function of detecting a walking state of a user holding the portable terminal 101, and a function of monitoring a situation.

At time 11:58:00, the user starts the application in the portable terminal 101. At this time, the user is stopped on the street.

At time 12:00:00, the taxi on which the wireless tag 103 is mounted is stopped in the vicinity of the user. A dashed line illustrates a range in which the wireless tag 103 is detected by the portable terminal 101 using short range wireless communication. At this time, the portable terminal 101 detects the wireless tag 103.

At time 12:00:01, the user starts walking. However, the detection of the walking state in the portable terminal 101 is performed later than a time point at which the user actually starts walking. In the example, the delay time is two seconds. Accordingly, at this time point, the portable terminal 101 does not detect the walking state.

At time 12:00:02, the user goes out of the range in which the wireless tag 103 is detected. At this time point also, the portable terminal 101 does not detect the walking state.

Then, at time 12:00:03, the portable terminal 101 detects the walking state. However, at this time, the portable terminal 101 does not detect the wireless tag 103.

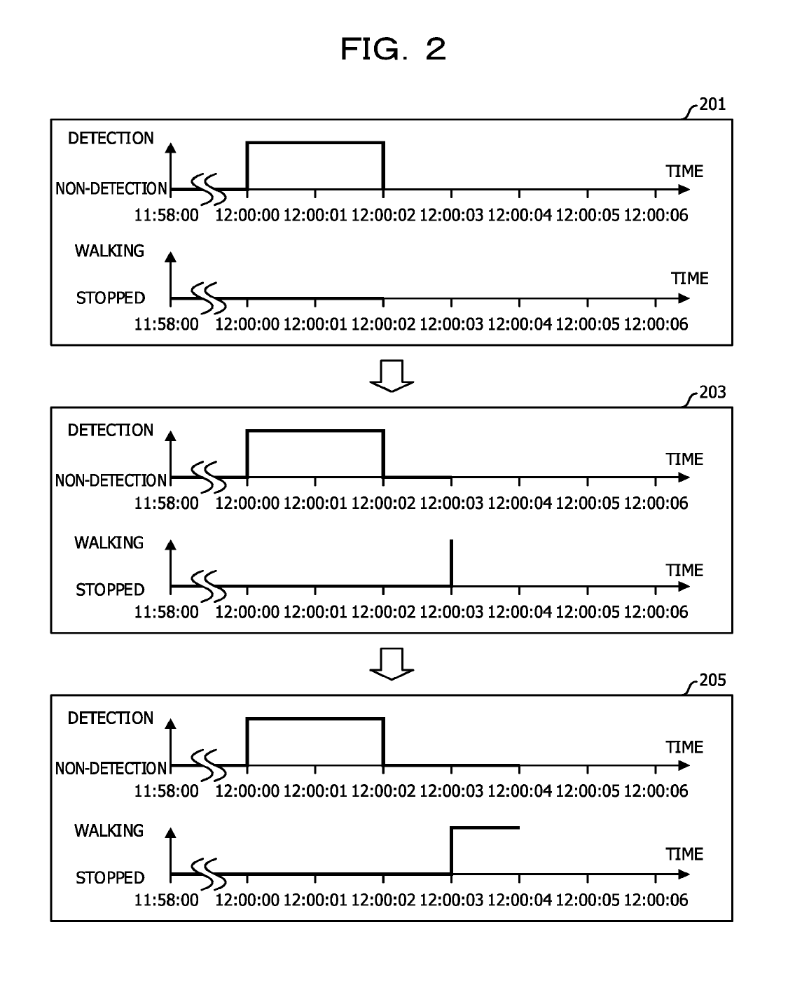

FIG. 2 illustrates status transition in the example of FIG. 1 captured by the portable terminal 101. A graph in a frame 201 illustrates status captured by the portable terminal 101 at time 12:00:02. An upper graph illustrates status (hereinafter, referred to as first status) according to the detection of the wireless tag 103. A lower graph illustrates status (hereinafter, referred to as second status) according to the walking state.

In a case where a starting condition that the first status is “detection” and the second status is “walking” is satisfied, the application in the example performs notification processing. Since the first status at time 12:00:02 is “non-detection”, and the second status is “stopped”, the application does not perform the notification processing.

A graph in a frame 203 illustrates status captured by the portable terminal 101 at time 12:00:03. The second status transitions to “walking”. However, since the first status is “non-detection”, application does not perform notification processing.

A graph in a frame 205 illustrates status captured by the portable terminal 101 at time 12:00:04. Even thereafter, the state does not satisfy the starting condition, the application does not perform the notification processing.

In the embodiment, as this example, a case in which, monitoring of situation fails due to the delay in the detection of the walking state even though the situation actually satisfies the starting condition, is suppressed.

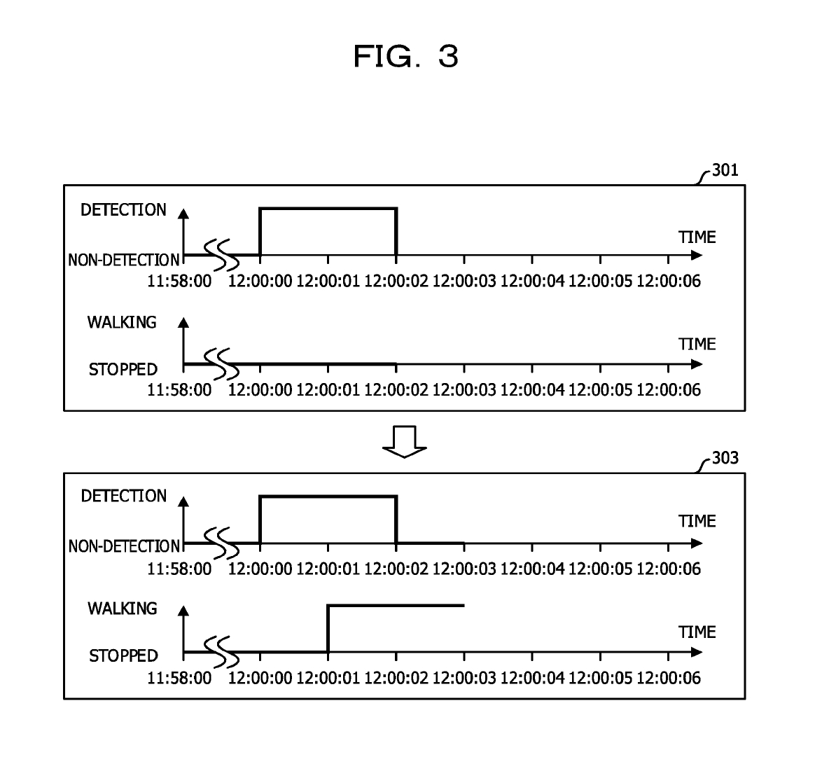

FIG. 3 illustrates an example of the status transition according to the embodiment. The graph within a frame 301 illustrates status captured by the portable terminal 101 at time 12:00:02. Status in the graph within the frame 301 is the same as the status in the graph within the frame 201 illustrated in FIG. 2. The second status is “stopped” at time 12:00:01 at which the walking actually starts.

A graph within a frame 303 illustrates status captured by the portable terminal 101 at time 12:00:03. Similar to the case of FIG. 2, the second status transitions to “walking” at time 12:00:03. However, in this embodiment, change in the second status to “walking” is retroactive to time 12:00:01 at which the walking actually starts.

As a result, a starting condition that the first status is “detection” and the second status is “walking” is satisfied during the period from the time 12:00:01 to time 12:00:02. In the embodiment, the second status is retroactively changed. In addition, whether the condition is satisfied is also retroactively determined. Accordingly, the notification processing by the application is performed at time 12:00:03.

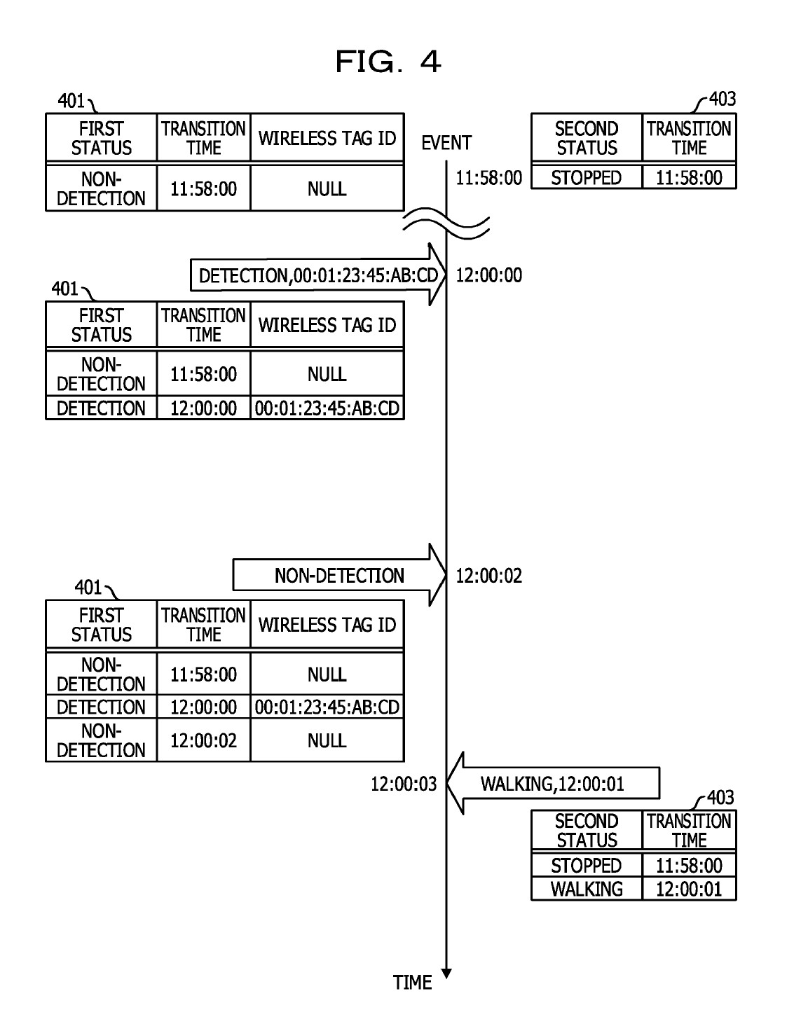

FIG. 4 illustrates an example of the table transition of the embodiment. The portable terminal 101 includes a first table 401 in which the first status is recorded, and a second table 403 in which the second status is recorded.

The first table 401 includes a record corresponding to the first status. The record of the first table 401 includes a field for setting the first status, a field for setting a transition time of the first status, and a field for setting a wireless tag ID. The first status indicates one of “detection” and “non-detection”.

In a case where the first status is “detection”, a time at which the first status transitions from “non-detection” to “detection” is set, and an ID of the wireless tag 103 that is detected is set in the record.

In a case where the first status is “non-detection”, a time at which the first status transitions from “detection” to “non-detection” is set. Furthermore, in a case where the first status is “non-detection”, NULL that means invalidity is set in a field for setting the wireless tag ID.

However, in this example, a time at which an event relating to the transition of the first status is generated is regarded as a transition time of the first status.

The second table 403 includes a record corresponding to the second status. The record of the second table 403 includes a field for setting the second status and a field for setting a transition time of the second status. The second status indicates one of “walking” and “stopped”.

In a case where the second status is the “walking”, a time at which the second status transitions from the “stopped” to the “walking” is set in the record. Meanwhile, in a case where the second status is “stopped”, a time at which the second status transitions from “walking” to “stopped” is set in the record.

In this example, the first record is provided in the first table 401 at time 11:58:00 when application starts. An initial value “non-detection” is set in a field of the first status of the first record. A starting time 11:58:00 is set in a field of transition time of the first record. In addition, NULL that means invalidity is set in a field of the wireless tag ID of the first record.

In addition, the first record is provided in the second table 403 at time 11:58:00 when application starts. An initial value “stopped” is set in a field of the second status of the first record. A starting time 11:58:00 is set in a field of the transition time of the first record.

Next, an event (hereinafter, referred to as “detection” event) indicating that the first status transitions to the “detection” is generated at time 12:00:00. An ID of the detected wireless tag 103 is included in the “detection” event relating to the first status. At this time, the second record is provided in the first table 401. The “detection” is set in a field of the first status of the second record based on the event. A time 12:00:00, at which the event is generated, is set in a field of the transition time of the second record. In addition, the wireless tag ID “00:01:23:45:AB:CD” included in the “detection” event relating to the first status is set in a field of the wireless tag ID of the second record.

In the determination at time 12:00:00 at which the “detection” event relating to the first status is generated, since the second status is now “stopped”, the starting condition is not satisfied. Accordingly, the notification processing is not performed.

Next, an event (hereinafter, referred to as “non-detection” event) indicating that the first status transitions to the “non-detection” is generated at time 12:00:02. At this time, the third record is provided in the first table 401. The “non-detection” is set in a field of the first status of the third record based on the event. A time 12:00:02, at which the event is generated, is set in a field of a transition time of the third record. NULL that means invalidity is set in a field of the wireless tag ID of the third record.

In the determination at time 12:00:02 at which the “non-detection” event relating to the first status is generated, since the first status is now the “non-detection”, and further the second status is now the “stopped”, the starting condition is not satisfied. Accordingly, the notification processing is not performed.

Next, an event (hereinafter, referred to as “walking” event) indicating that the second status transitions to the “walking” is generated at time 12:00:03. A time at which the walking starts, that is, a transition time “12:00:01” is included in the “walking” event relating to the second status. At this time, the second record is provided in the second table 403. The “walking” is set in a field of the second status of the second record based on the event. A transition time “12:00:01”, included in the “walking” event relating to the second status is set in a field of a transition time of the second record.

In the determination at time 12:00:03 at which the “walking” event relating to the second status is generated, since the first status at time 12:00:01 is “detection”, and the second status is “walking”, the starting condition is satisfied. Accordingly, the notification processing is performed. The description on the outline of the embodiment described above is completed.

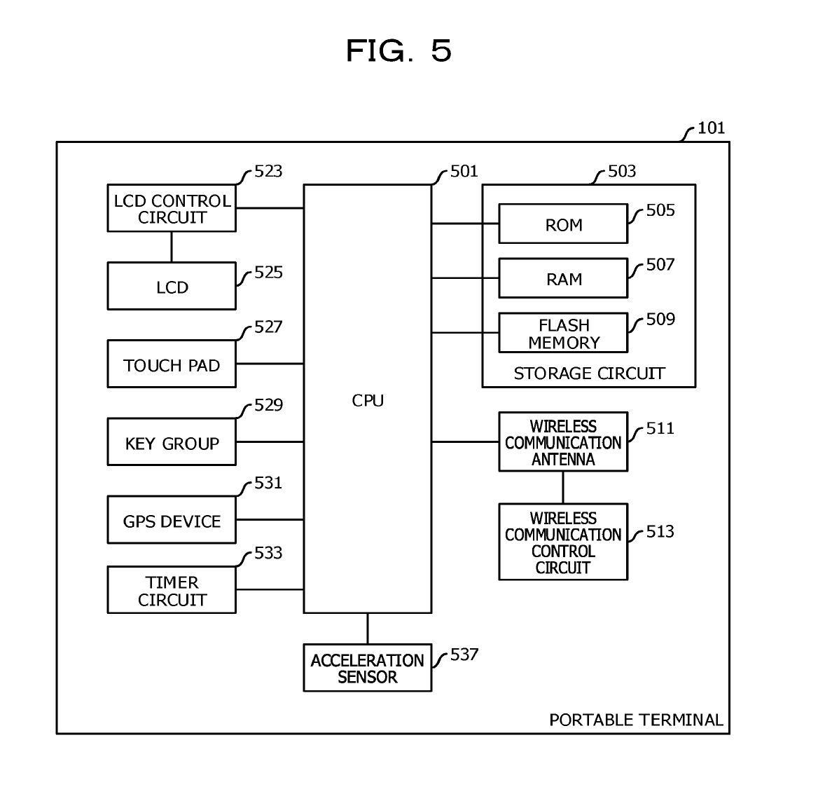

Hereinafter, the operation of the portable terminal 101 will be described. First, a hardware configuration of the portable terminal 101 in the embodiment will be described. FIG. 5 illustrates an example of a hardware configuration of the portable terminal 101. The portable terminal 101 includes a central processing unit (CPU) 501, a storage circuit 503, a wireless communication antenna 511, a wireless communication control circuit 513, a liquid crystal display (LCD) control circuit 523, an LCD 525, a touch pad 527, a key group 529, a global positioning system (GPS) device 531, a timer circuit 533, and an acceleration sensor 537.

The CPU 501 executes a program stored in the storage circuit 503. The storage circuit 503 includes, for example, a read only memory (ROM) 505, a random access memory (RAM) 507, and a flash memory 509. The ROM 505 stores, for example, a fundamental program and initial data. The RAM 507 includes an area for expanding the program. The RAM 507 includes also an area for temporarily storing data. The flash memory 509 stores, for example, programs such as applications and user data.

The LCD control circuit 523 operates a clock circuit at a predetermined operational frequency, and operates the LCD 525. The LCD 525 displays a variety of images. The touch pad 527 is, for example, a panel-shaped sensor arranged on a screen of the LCD 525, and receives an instruction by touch operations. Specifically, a touch panel in which the LCD 525 and the touch pad 527 are integrated is used. Each of hard keys of the key group 529 is provided on a part of a housing.

The wireless communication antenna 511, for example, receives wireless waves by a cellular technology, a wireless local area network (LAN) technology, or a short range communication technology (for example, Bluetooth (registered trademark) low energy). The wireless communication control circuit 513 performs controlling of wireless communication according to the usage frequency of each technology. The wireless communication control circuit 513, for example, is used to detect the wireless tag 103 that outputs a radio signal in the vicinity.

The acceleration sensor 537 measures acceleration. Specifically, the acceleration sensor 537 measures acceleration in each direction of three orthogonal axes.

In the example, the acceleration sensor 537 is connected to the CPU 501. Accordingly, the CPU 501 directly obtains a measurement result of the acceleration sensor 537.

Furthermore, the portable terminal 101 illustrated in FIG. 5 is a mobile phone (including feature phone and smart phone), and an example of a portable electronic device. However, the embodiment may be applied to other portable electronic devices. For example, the same module as the portable terminal 101 may be provided in portable electronic devices, such as wearable terminals of a wristwatch type and an eyeglasses type, tablet terminals, game machines, pedometers, recorders, music players, cameras, image reproduction machines, television broadcast receivers, radio broadcast receivers, controllers, electronic watches, electronic dictionaries, electronic translators, radios, GPS transmitters, measuring instruments, health support equipment, or medical equipment, and may perform the following processing.

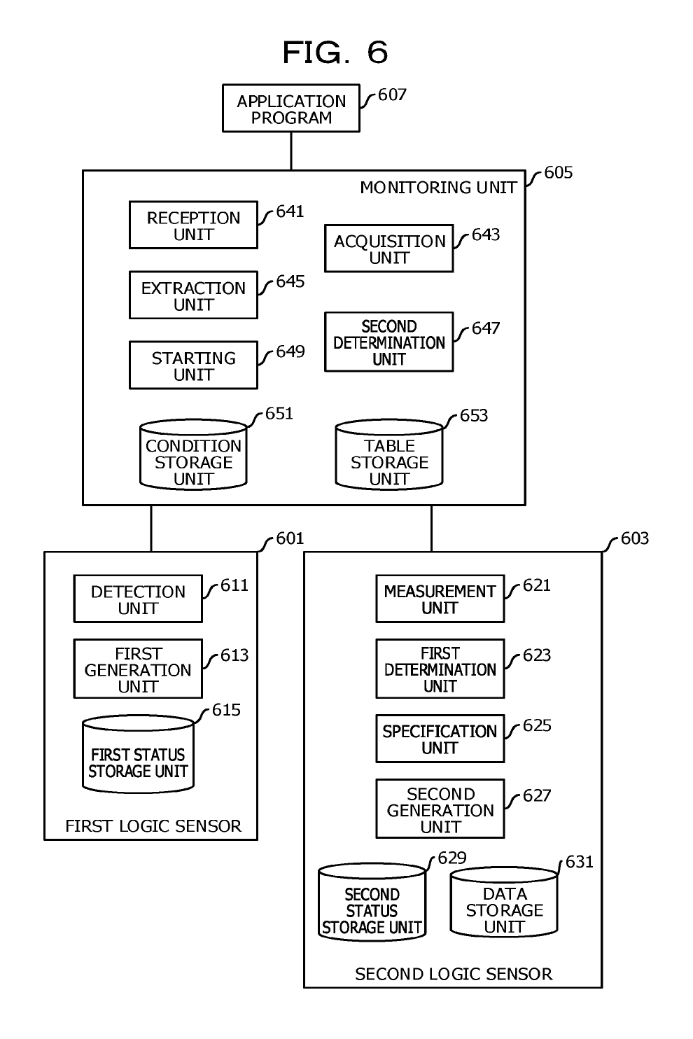

Next, a module of the portable terminal 101 will be described. FIG. 6 illustrates an example of a module configuration of the portable terminal 101. The portable terminal 101 includes a first logic sensor 601, a second logic sensor 603, a monitoring unit 605, and an application program 607. The first logic sensor 601 performs first detection processing that detects the first status. The second logic sensor 603 performs processing that measures the acceleration and second detection processing that detects the second status. The monitoring unit 605 performs monitoring processing. The application program 607 performs predetermined processing (notification processing in this example) according to a determination result in the monitoring unit 605 by using the first logic sensor 601, the second logic sensor 603, and the monitoring unit 605.

The first logic sensor 601 includes a detection unit 611, a first generation unit 613, and a first status storage unit 615. The detection unit 611 detects the wireless tag 103 by controlling the wireless communication control circuit 513 so as to receive a wireless signal generated from nearby. The first generation unit 613 generates an event relating to the transition of the first status. The first status storage unit 615 stores a current first status.

The second logic sensor 603 includes a measurement unit 621, a first determination unit 623, a specification unit 625, a second generation unit 627, a second status storage unit 629, and a data storage unit 631. The measurement unit 621 measures acceleration by using the acceleration sensor 537. The first determination unit 623 performs determination of the walking state based on the time-series data of the acceleration. The specification unit 625 specifies the transition time of the second status. The second generation unit 627 generates an event relating to the transition of the second status. The second status storage unit 629 stores current second status. The data storage unit 631 stores the time-series data of the acceleration.

The monitoring unit 605 includes a reception unit 641, an acquisition unit 643, an extraction unit 645, a second determination unit 647, a starting unit 649, a condition storage unit 651, and a table storage unit 653. The reception unit 641 receives a starting condition from the application program 607. The acquisition unit 643 acquires an event relating to transition of the first status and an event relating to transition of the second status. The extraction unit 645 extracts the first status used in condition determination from the first table 401. Furthermore, the extraction unit 645 extracts the second status used in the condition determination from the second table 403. The second determination unit 647 performs the condition determination. The starting unit 649 starts predetermined processing (in this example, notification processing by the application program 607). The condition storage unit 651 stores a starting condition. The table storage unit 653 stores the first table 401 and the second table 403.

The first logic sensor 601, the second logic sensor 603, the monitoring unit 605, the detection unit 611, the first generation unit 613, the measurement unit 621, the first determination unit 623, the specification unit 625, the second generation unit 627, the reception unit 641, the acquisition unit 643, the extraction unit 645, the second determination unit 647, and the starting unit 649 described above are realized by using hardware resources (for example, FIG. 5) and a program that causes a processor to perform processing described below.

The first status storage unit 615, the second status storage unit 629, the data storage unit 631, the condition storage unit 651, and the table storage unit 653 described above are realized by using hardware resources (for example, FIG. 5).

Furthermore, when the application program 607 starts by a user's operation, the application program 607 starts processing of the first logic sensor 601, the second logic sensor 603, and the monitoring unit 605. That is, processing of the first logic sensor 601, the second logic sensor 603, and the monitoring unit 605 also starts in association with processing of the application program 607. Furthermore, the application program 607, the first logic sensor 601, the second logic sensor 603, and the monitoring unit 605 perform processing in parallel.

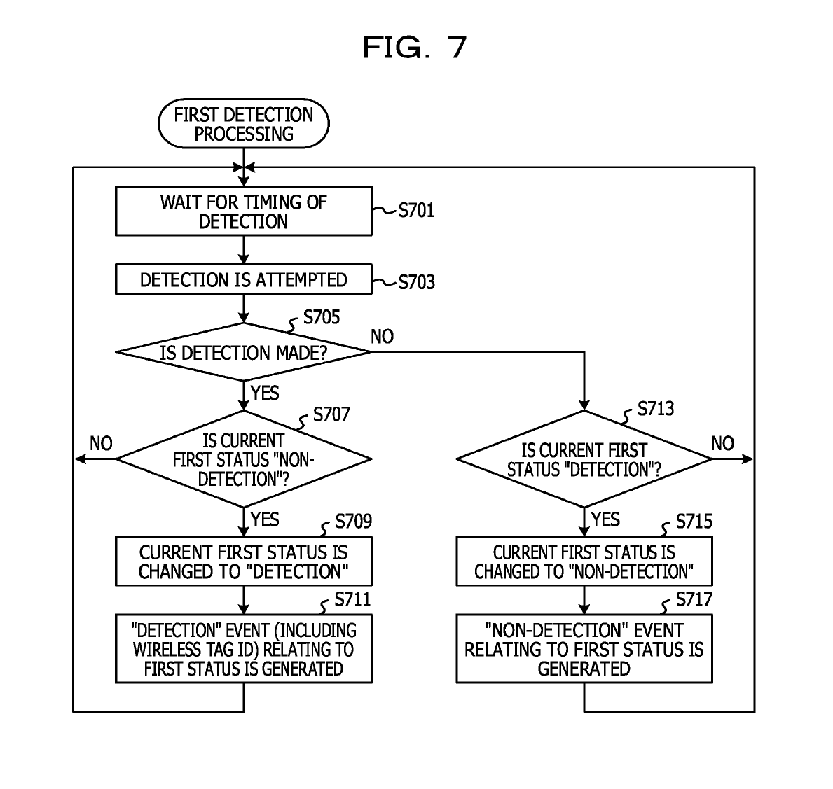

First, the first detection processing by the first logic sensor 601 will be described. FIG. 7 illustrates an example of a first detection processing flow. The detection unit 611 waits for a timing to detect the wireless tag 103 (S701). In this example, the detection unit 611 detects the wireless tag 103 at predetermined intervals. When approaching the timing, the detection unit 611 attempts detection of the wireless tag 103 (S703). That is, the detection unit 611 performs an operation that searches for the wireless tag 103 in the vicinity by using the wireless communication antenna 511 and the wireless communication control circuit 513.

The first generation unit 613 determines whether or not the wireless tag 103 is detected (S705). In a case where it is determined that the wireless tag 103 is detected, the first generation unit 613 determines whether or not current first status stored in the first status storage unit 615 is “non-detection” (S707).

In a case where it is determined that the current first status stored in the first status storage unit 615 is not “non-detection”, that is, in a case where the first status is “detection”, the first status is not changed. Accordingly, the processing returns to processing of S701, and the above-described processing is repeated.

Meanwhile, in a case where it is determined that current first status stored in the first status storage unit 615 is “non-detection”, the first generation unit 613 changes the current first status to “detection” (S709). The first generation unit 613 generates a “detection” event relating to the first status (S711). An ID of the detected wireless tag 103 is stored in the “detection” event relating to the first status. The “detection” event relating to the first status is transferred to the monitoring unit 605. Accordingly, the processing returns to processing of S701, and the above-described processing is repeated.

The description returns to the explanation of the determination in S705. In a case where it is determined that the wireless tag 103 is not detected in S705, the first generation unit 613 determines whether or not current first status stored in the first status storage unit 615 is “detection” (S713).

In a case where it is determined that the current first status stored in the first status storage unit 615 is not “detection”, that is, in a case where the first status is “non-detection”, the first status is not changed. Accordingly, the processing returns to processing of S701, and the above-described processing is repeated.

Meanwhile, in a case where it is determined that the current first status stored in the first status storage unit 615 is “detection”, the first generation unit 613 changes the current first status to “non-detection” (S715). The first generation unit 613 generates a “non-detection” event relating to the first status (S717). The “non-detection” event relating to the first status is transferred to the monitoring unit 605. Accordingly, the processing returns to processing of S701, and the above-described processing is repeated. The description on the first detection processing is completed.

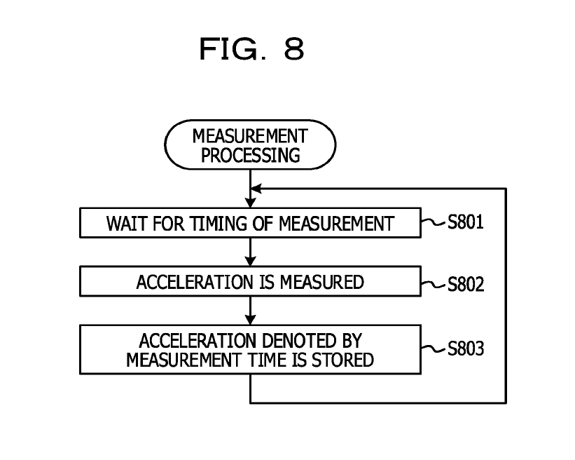

Next, measurement processing and the second detection processing by the second logic sensor 603 will be described. The measurement processing is performed in parallel with the second detection processing. FIG. 8 illustrates an example of a measurement processing flow. The measurement unit 621 waits for a timing to measure acceleration (S801). In this example, the detection unit 611 measures the acceleration at predetermined intervals. When approaching the timing, the measurement unit 621 measures the acceleration by using the acceleration sensor 537 (S803). The measurement unit 621 stores the acceleration in which a measurement time is denoted in the data storage unit 631 (S805). Accordingly, the processing returns to processing of S801, and the above-described processing is repeated.

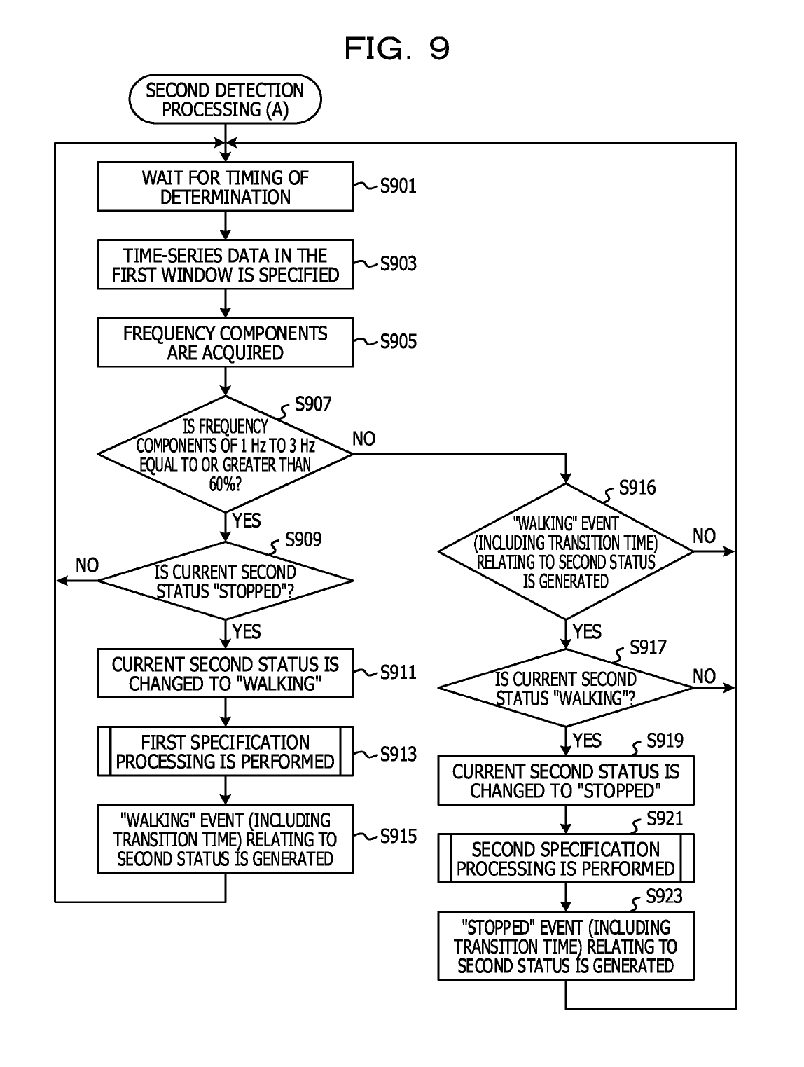

In the embodiment, the second detection processing (A) is performed. FIG. 9 illustrates an example of a second detection processing (A) flow. The first determination unit 623 waits for a timing to determine a walking state (S901). In this example, the first determination unit 623 performs determination of the walking state at predetermined intervals.

When approaching the timing, the first determination unit 623 specifies time-series data in a first window among acceleration data stored in the data storage unit 631 (S903). The first window corresponds to a period that is a determination target.

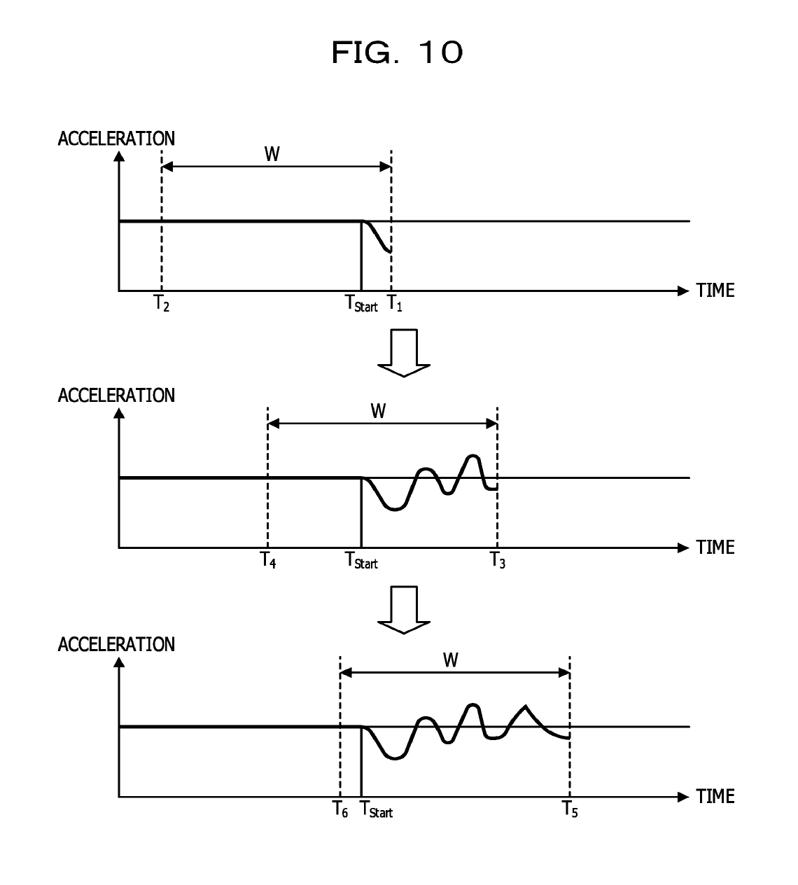

FIG. 10 illustrates an example of the first window. A start time point of the first window is earlier than a current time by a predetermined time W (referred to as first window length). A termination time point of the first window is the current time.

A vertical axis of a graph illustrated in FIG. 10 schematically illustrates variation of the acceleration. Similarly, a horizontal axis illustrates time. Furthermore, actual acceleration is a three-dimensional value.

The first stage illustrates the first window at time T₁. The time-series data of acceleration from a start time point T₂ to the termination time point T₁ of the first window is the determination target. Furthermore, in this example, a time (referred to as starting time) Tₛₜₐᵣₜ, at which the walking starts, is included in the first window. However, a ratio of the period corresponding to the walking is small and accuracy of periodicity is low, in the time-series data in the first window. Accordingly, it is determined that the second status is “stopped”.

The second stage illustrates the first window in time T₃. The time-series data of acceleration from a start time point T₄ of the first window to a termination time point T₃ is the determination target. A ratio of the period corresponding to the walking is small in the time-series data in the first window. Accordingly, it is determined that the second status is “stopped”.

The third stage illustrates the first window at time T₅. The time-series data of acceleration from a start time point T₆ to a termination time point T₅ of the first window is the determination target. A ratio of the period corresponding to the walking is large, and accuracy of periodicity is high in the time-series data in the first window. Accordingly, it is determined that the second status is “walking”.

The description returns to the description of FIG. 9. The first determination unit 623 performs Fourier transform with respect to the time-series data of acceleration in the first window, and obtains frequency components included in the time-series data of the acceleration (S905). The first determination unit 623 uses two thresholds relating to the ratio of the frequency components (in this example, frequency of 1 Hz to 3 Hz) indicating the periodicity associated with the walking. The first determination unit 623 determines whether or not, first, a ratio of frequency components of 1 Hz to 3 Hz is equal to or greater than an upper threshold (for example, 60%) (S907). In a case where the ratio of frequency components of 1 Hz to 3 Hz is equal to or greater than the upper threshold, it is considered that the user is walking.

In a case where it is determined that the ratio of frequency components of 1 Hz to 3 Hz is equal to or greater than the upper threshold, the first determination unit 623 determines whether or not current second status stored in the second status storage unit 629 is “stopped” (S909).

In a case where it is determined that the current second status stored in the second status storage unit 629 is not “stopped”, that is, in a case where the current second status is “walking”, the second status is not changed. Accordingly, the processing returns to processing of S901, and the above-described processing is repeated.

Meanwhile, in a case where it is determined that the current second status stored in the second status storage unit 629 is “stopped”, the first determination unit 623 changes the current second status to “walking” (S911). Accordingly, the specification unit 625 performs first specification processing (S913). The second window is set in the first window, and a starting time Tₛₜₐᵣₜ is specified, in the first specification processing.

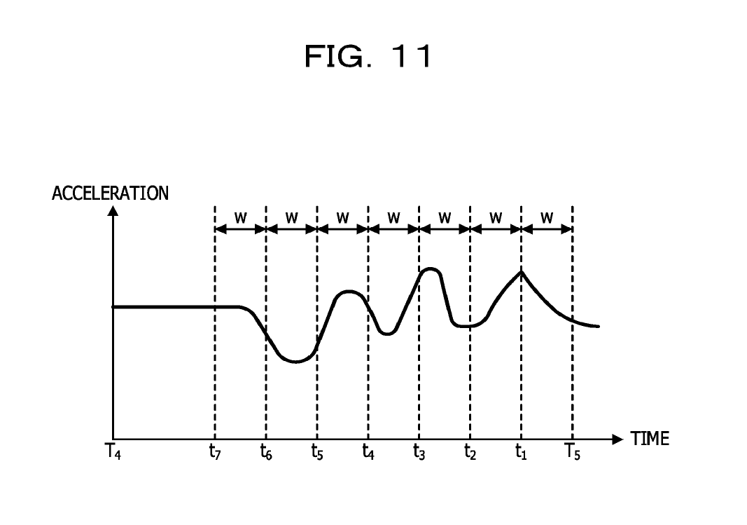

FIG. 11 illustrates an example of the second window. The length of the second window is shorter than that of the first window. The length of the second window is set in such a manner that variation in waveform that represents the periodicity associated with the walking can be detected. In this example, the first window is divided by a predetermined time w. Each period that is obtained by the division corresponds to the second window. In examples of the first specification processing and the second specification processing which are described below, the second window moves from a termination time point side of the first window to a start time point side in this order.

FIG. 11 illustrates an example of the second window set with respect to the first window illustrated in the third stage of FIG. 10. In the example illustrated in FIG. 11, first, the second window from the first start time point t₁ to a termination time point T₅ is set. Then, the second window from a start time point t₂ to a termination time point t₁, the second window from a start time point t₃to a termination time point t₂, the second window from a start time point t₄ to a termination time point t₃, the second window from a start time point t₅ to a termination time point t₄, the second window from a start time point t₆ to a termination time point t₅, and the second window from a start time point t₇ to a termination time point t₆ are set. In this example, since it is determined that the user is not moving as a result of the analysis on an acceleration signal in the second window from the start time point t₇ to the termination time point t₆, it is determined that a start time point Tₛₜₐᵣₜ is t₆.

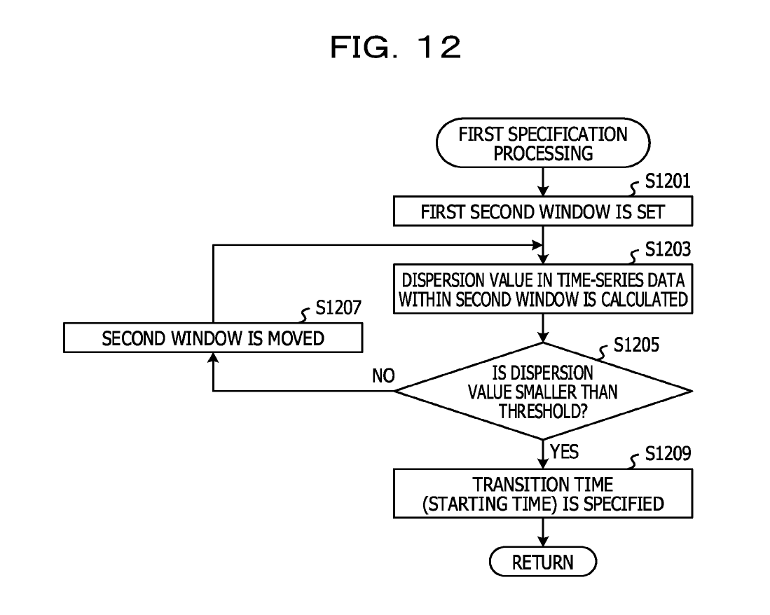

FIG. 12 illustrates an example of a first specification processing flow. The specification unit 625 sets the first second window (S1201). The specification unit 625 calculates a dispersion value of acceleration in the time-series data within the second window (S1203). Accordingly, the specification unit 625 determines whether or not the dispersion value of the acceleration is smaller than a threshold (S1205).

In a case where it is determined that the dispersion value of the acceleration is not smaller than the threshold, that is, in a case where the dispersion value of the acceleration is equal to or greater than the threshold, the specification unit 625 moves the second window by the length of the second window in the past direction (S1207). Accordingly, the processing returns to processing of S1203, and the above-described processing is repeated.

Meanwhile, in a case where it is determined that the dispersion value of the acceleration is smaller than the threshold, the specification unit 625 specifies the transition time of the second status (S1209). In a case of the first specification processing, the transition time of the second status indicates the starting time Tₛₜₐᵣₜ. For example, the specification unit 625 specifies, as the transition time of the second status, a termination time point of the second window at which it is determined that the dispersion value of the acceleration is smaller than the threshold. However, the specification unit 625 may specify other time points included in the second window. For example, the specification unit 625 may specify a start time point of the second window. The specification unit 625 may specify a central time point of the second window. When the first specification processing is completed, the processing precedes to processing of S915 illustrated in FIG. 9.

Furthermore, in the first specification processing, the transition time of the second status may be specified by a method different from the example illustrated in FIG. 12. For example, the specification unit 625 may specify a start time point of the first window at which the change in the second status is detected, as the transition time of the second status. Alternatively, the specification unit 625 may specify a time earlier than a termination time point of the first window at which change in the second status is detected by a predetermined time, as the transition time of the second status.

The description returns to the description of FIG. 9. The second generation unit 627 generates a “walking” event relating to the second status (S915). In this example, an event relating to the second status includes the transition time of the second status. In the “walking” event relating to the second status, a starting time Tₛₜₐᵣₜ is set, as the transition time. The “walking” event relating to the second status is transferred to the monitoring unit 605. Accordingly, the processing returns to processing of S901, and the above-described processing is repeated.

The description returns to the description of the determination in S907. In a case where it is determined that a ratio of frequency components of 1 Hz to 3 Hz is not equal to or greater than a upper threshold, that is, in a case where the ratio of frequency components of 1 Hz to 3 Hz is below the upper threshold, the first determination unit 623 determines whether or not the ratio of frequency components of 1 Hz to 3 Hz is equal to or smaller than a lower threshold (for example, 20%) (S916).

In a case where the ratio of frequency components of 1 Hz to 3 Hz is equal to or smaller than the lower threshold, it is considered that the user is stopped. Furthermore, in a case where the ratio of frequency components of 1 Hz to 3 Hz is not equal to or smaller than the lower threshold, since the reliability of the state determination is low, the processing returns to processing of S901, and the above-described processing is repeated.

Meanwhile, in a case where it is determined that the ratio of frequency components of 1 Hz to 3 Hz is equal to or smaller than the lower threshold, the first determination unit 623 determines whether or not current second status stored in the second status storage unit 629 is “walking” (S917).

In a case where it is determined that the current second status stored in the second status storage unit 629 is not “walking”, that is, in a case where the current second status is “stopped”, the second status is not changed. Accordingly, the processing returns to processing of S901, and the above-described processing is repeated.

Meanwhile, in a case where it is determined that the current second status stored in the second status storage unit 629 is “walking”, the first determination unit 623 changes the current second status to “stopped” (S919).

Accordingly, the specification unit 625 performs the second specification processing (S921). In the second specification processing, the second window is set within the first window, and a time at which the user is stopped (referred as to stop time) is specified.

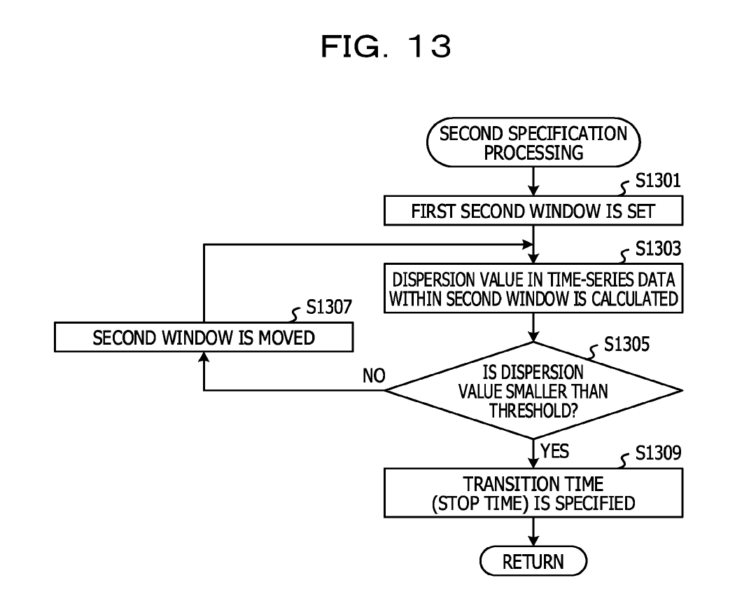

FIG. 13 illustrates an example of a second specification processing flow. The specification unit 625 sets the first second window (S1301). The specification unit 625 calculates a dispersion value of acceleration in the time-series data within the second window (S1303). The specification unit 625 determines whether or not the dispersion value of acceleration is greater than a threshold (S1305).

In a case where it is determined that the dispersion value of acceleration is not greater than the threshold, that is, in a case where the dispersion value of acceleration is equal to or smaller than the threshold, the specification unit 625 moves the second window by the length of the second window in the past direction (S1307). Accordingly, the processing returns to processing of S1303, and the above-described processing is repeated.

Meanwhile, in a case where it is determined that the dispersion value of acceleration is greater than the threshold, the specification unit 625 specifies the transition time of the second status (S1309). In a case of the second specification processing, the transition time of the second status indicates a stop time. For example, the specification unit 625 specifies a termination time point of the second window at which it is determined that a dispersion value of acceleration is greater than a threshold, as the transition time of the second status. However, the specification unit 625 may specify other time points included in the second window. For example, the specification unit 625 may specify a start time point of the second window. The specification unit 625 may specify a central time point of the second window. When the second specification processing is completed, the processing precedes to S923 illustrated in FIG. 9.

Furthermore, in the second specification processing, the transition time of the second status may be specified by other methods. For example, the specification unit 625 may specify a start time point of the first window as the transition time of the second status. Alternatively, the specification unit 625 may specify a time earlier than a termination time point of the first window by a predetermined time as the transition time of the second status.

The description returns to the description of FIG. 9. The second generation unit 627 generates an event (hereinafter, referred to as “stopped” event) indicating that the second status transitions to “stopped” (S923). In the “stopped” event relating to the second status, a stop time is set as the transition time. The “stopped” event relating to the second status is transferred to the monitoring unit 605. Accordingly, the processing returns to processing of S901, and the above-described processing is repeated. The description of the second detection processing (A) is completed.

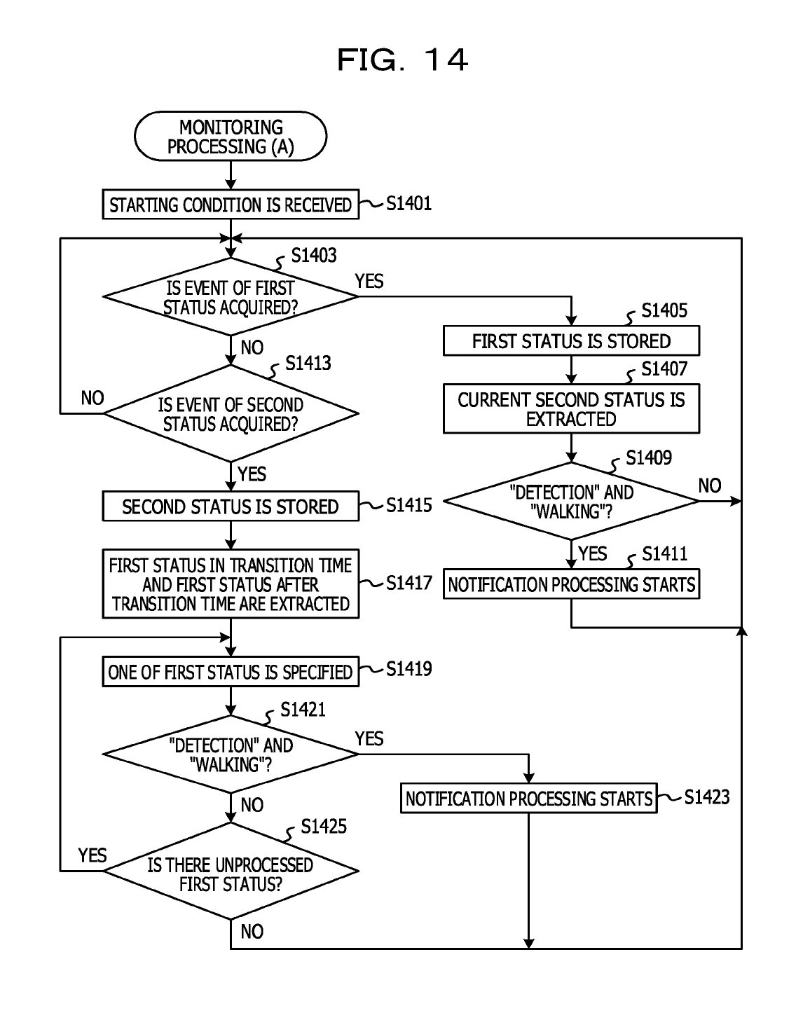

Next, monitoring processing by the monitoring unit 605 will be described. In the embodiment, the monitoring processing (A) is performed. FIG. 14 illustrates an example of a monitoring processing (A) flow. The reception unit 641 receives a starting condition from the application program 607 (S1401). The reception unit 641 stores the received starting condition in the condition storage unit 651. The starting condition in this example is that the first status is “detection” and the second status is “walking”.

The acquisition unit 643 determines whether or not an event relating to transition of the first status from the first logic sensor 601 is acquired (S1403).

In a case where it is determined that the event relating to transition of the first status from the first logic sensor 601 is acquired, the acquisition unit 643 stores the first status in the table storage unit 653 (S1405). Specifically, the acquisition unit 643 provides a new record in the first table 401. Accordingly, the acquisition unit 643 sets the first status and the transition time in the new record. In this example, a time at which an event relating to transition of the first status is acquired is considered as the transition time. Furthermore, in a case where the first status is “detection”, the acquisition unit 643 sets the wireless tag ID included in the event acquired in S1403 in the new record. In a case where the first status is “non-detection”, NULL that means invalidity is set in a field of the wireless tag ID.

The extraction unit 645 extracts the current second status from the second table 403 (S1407). In this example, the current second status is the second status in the new record of the second table 403.

The second determination unit 647 determines whether or not the starting condition is satisfied (S1409). In this example, it is determined whether the first status of the event acquired in S1403 is “detection”, and current second status is “walking”.

In a case where it is determined whether or not the starting condition is not satisfied, the processing returns to processing of S1403, and the above-described processing is repeated.

Meanwhile, in a case where it is determined that the starting condition is satisfied, the starting unit 649 starts the notification processing by the application program 607 (S1411). A method for starting predetermined processing by the application program 607 is optional. For example, the starting unit 649 may transfer a command to the application program 607. The starting unit 649 may use a queue. Accordingly, the processing returns to processing of S1403, and the above-described processing is repeated.

The application program 607 performs the notification processing that has started up. In this example, the application program 607 outputs sound for the notification as described above. Furthermore, the application program 607 displays an image informing the user that the taxi is in the vicinity. Furthermore, contents of the processing started up by the starting unit 649 are optional. The starting unit 649, for example, may start processing, such as sending of mail, the output of an advertisement screen, sound output, photography, sound recording, controlling of a device and a power source, and the like.

The description returns to the description of the determination in S1403. In a case where it is determined that an event relating to transition of the first status from the first logic sensor 601 is not acquired in S1403, the acquisition unit 643 determines whether or not an event relating to transition of the second status from the second logic sensor 603 is acquired (S1413).

In a case where it is determined that an event relating to transition of the second status from the second logic sensor 603 is not acquired, the processing returns to processing of S1403, and the above-described processing is repeated.

Meanwhile, in a case where it is determined that the event relating to transition of the second status from the second logic sensor 603 is acquired, the acquisition unit 643 stores the second status in the table storage unit 653 (S1415). Specifically, the acquisition unit 643 provides a new record in the second table 403. Accordingly, the acquisition unit 643 sets the second status and the transition time in the new record. The transition time of the second status is included in the event acquired in S1413, as described above.

The extraction unit 645 extracts the first status in the transition time of the second status and a first status after the transition time of the second status from the first table 401 (S1417). Specifically, the extraction unit 645 extracts the first status of the latest transition time among transition times of the first status corresponding to a time point before the transition time of the second status. Furthermore, the extraction unit 645 extracts a first status subsequent to the latest first status of the latest transition time.

In FIG. 4, a case where the monitoring unit 605 acquires a “walking” event relating to the second status at time 12:00:03 is specifically described, as an example. A transition time 11:58:00 (first record) before a transition time 12:00:01 included in the event relating to transition of the second status and a transition time 12:00:00 (second record) are set in the first table 401 at time 12:00:03. Among them, “detection” (second record) of the second status at the latest transition time 12:00:00 is extracted. Then, next second status “non-detection” (third record) is extracted.

The description returns to the description of FIG. 14. The second determination unit 647 specifies one item of the extracted first status (S1419). The second determination unit 647 determines whether or not a starting condition is satisfied (S1421). In this example, it is determined whether or not the first status specified in S1419 is “detection” and the second status indicated by the event acquired in S1413 is “walking”.

In a case where it is determined that the starting condition is satisfied, the starting unit 649 starts the notification processing by the application program 607 (S1423). Contents of the notification processing are the same as a case of S1411.

Meanwhile, in a case where it is determined that a starting condition is not satisfied, the second determination unit 647 determines whether or not there is a first status that is not processed (S1425). In a case where it is determined that there is a first status that is not processed, the processing returns to processing of S1419, and the above-described processing is repeated. In a case where there is not the first status that is not processed, the notification processing does not start. Accordingly, the processing returns to processing of S1403, and the above-described processing is repeated. Hereinabove, description of the outline of the monitoring processing (A) is completed.

According to the embodiment, it is possible to accurately capture a state of the combination of a plurality of statuses. Specifically, it is possible to more accurately capture the state of the combination of the other statuses, even in a case of the detection of one of the statuses is delayed.

In addition, since a starting condition with respect to a first status in the transition time of a second status and a first status after the transition time of the second status is determined, it is possible to suppress missing of a state according to a combination of a plurality of statuses.

### Second Embodiment

In the embodiment, an example in which a length of a time interval between a transition time of the second status and a generation time of an event relating to the transition of the second status is limited will be described.

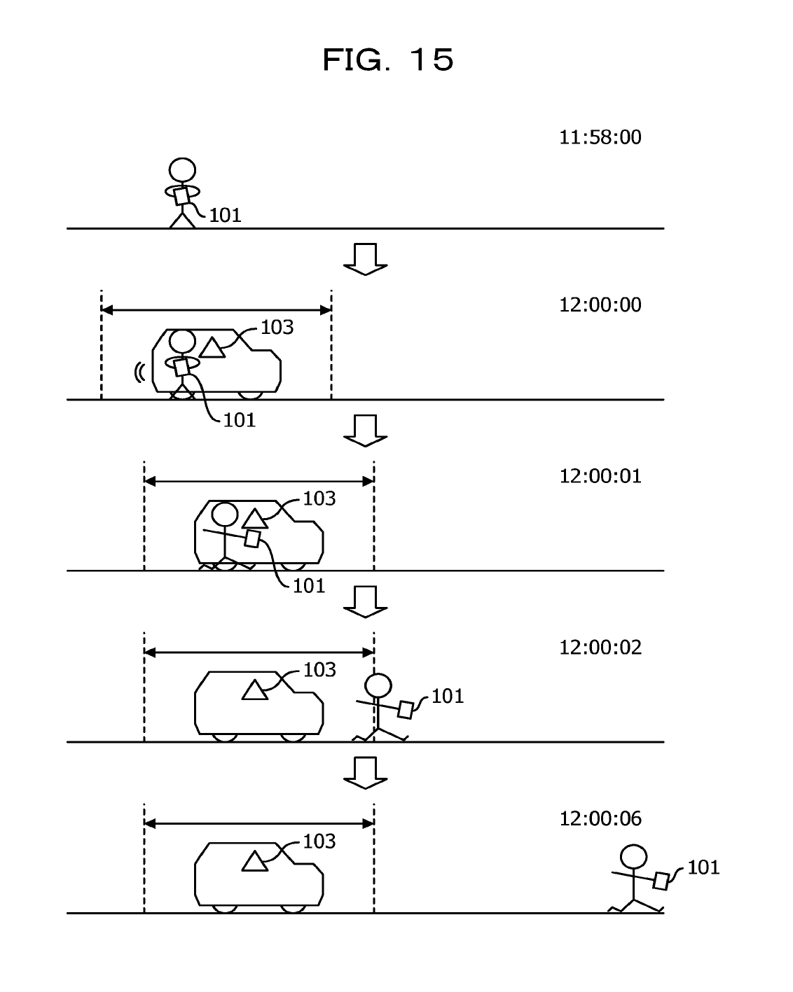

FIG. 15 illustrates an embodiment of the usage of the portable terminal 101. In this example, it is assumed that a delay time according to detection of a walking state is five seconds. A situation of a time 11:58:00 to a time 12:00:02 is the same as the case of FIG. 1.

Accordingly, the portable terminal 101 detects a walking state at a time 12:00:06. At this time, the portable terminal 101 does not detect the wireless tag 103. The timing for detecting the walking state is later than in the example illustrated in FIG. 1. In this case, notification in a position where the user leaves a taxi may be wasted. Accordingly, the length of the time interval is at most two seconds. In the embodiment, an allowable time interval (hereinafter, referred to as allowed time) is set.

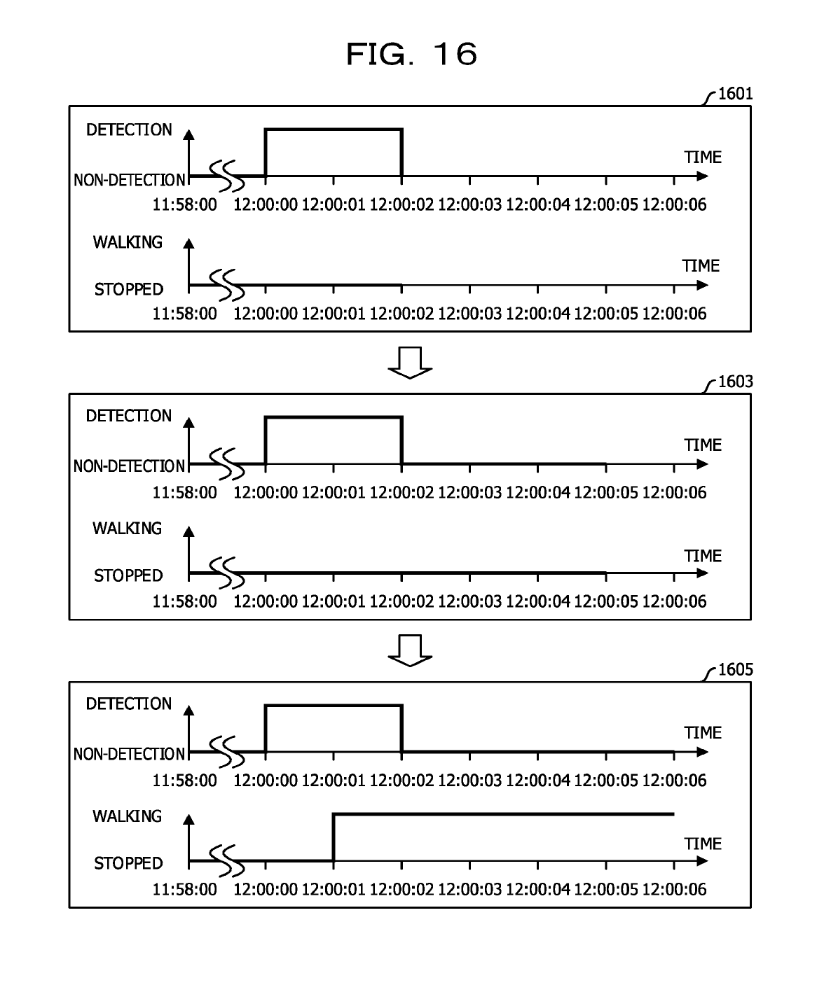

FIG. 16 illustrates an example of the status transition of a case where the first embodiment is applied in the example of FIG. 15. A graph within a frame 1601 illustrates a status in which the portable terminal 101 is captured at a time 12:00:02. The status in the graph within the frame 1601 is the same as the status in the graph within the frame 301 illustrated in FIG. 3.

A graph within a frame 1603 illustrates a status in which the portable terminal 101 is captured at a time 12:00:05. At this time, the second status is still “stopped”.

A graph within a frame 1605 illustrates a status in which the portable terminal 101 is captured at a time 12:00:06. At this time, the second status precedes to “walking”. In a case of the first embodiment, the change in the second status to “walking” is retroactive to a time 12:00:01 at which the walking has actually started. That is, in a case where the first embodiment is applied, the time interval of five seconds is obtained. However, in the second embodiment, the time interval of more than two seconds that is the allowed time is not suitable to the purpose of the application program 607.

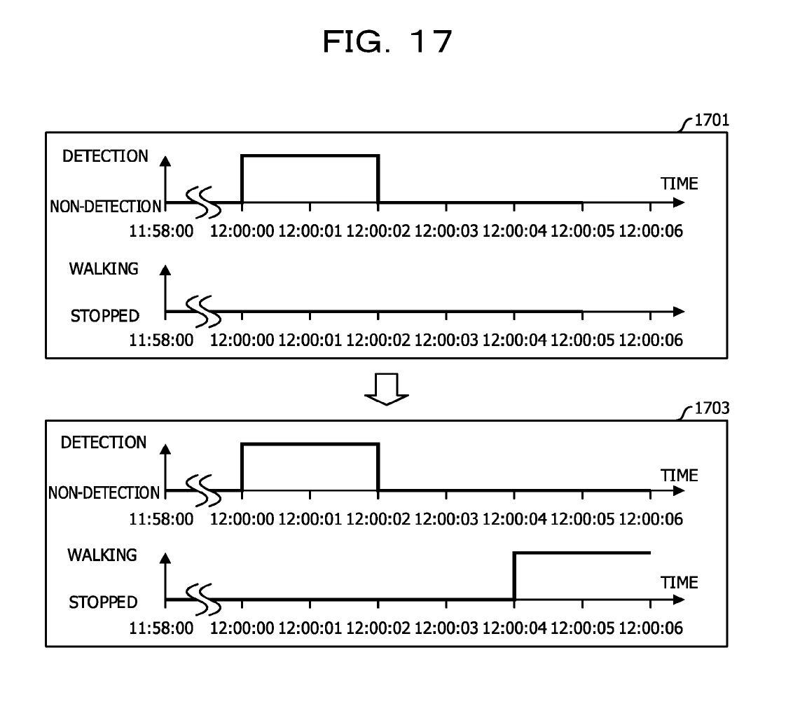

FIG. 17 illustrates an example of the status transition in the second embodiment. A graph within a frame 1701 illustrates a status in which the portable terminal 101 is captured at a time 12:00:05. The status in the graph within the frame 1701 is the same as the status in the graph within the frame 1603 illustrated in FIG. 16.

A graph within a frame 1703 illustrates a status in which the portable terminal 101 is captured at a time 12:00:06. At this time, the second status precedes to “walking”. Five seconds from current time 12:00:06 to a time 12:00:01, at which the walking starts, exceeds the allowable time of two seconds. Accordingly, the second status is changed to “walking” retroactively to a time 12:00:04 which is two seconds (allowed time) earlier than the current time 12:00:06. Accordingly, starting condition is not satisfied and notification processing at time 12:00:06 is not performed.

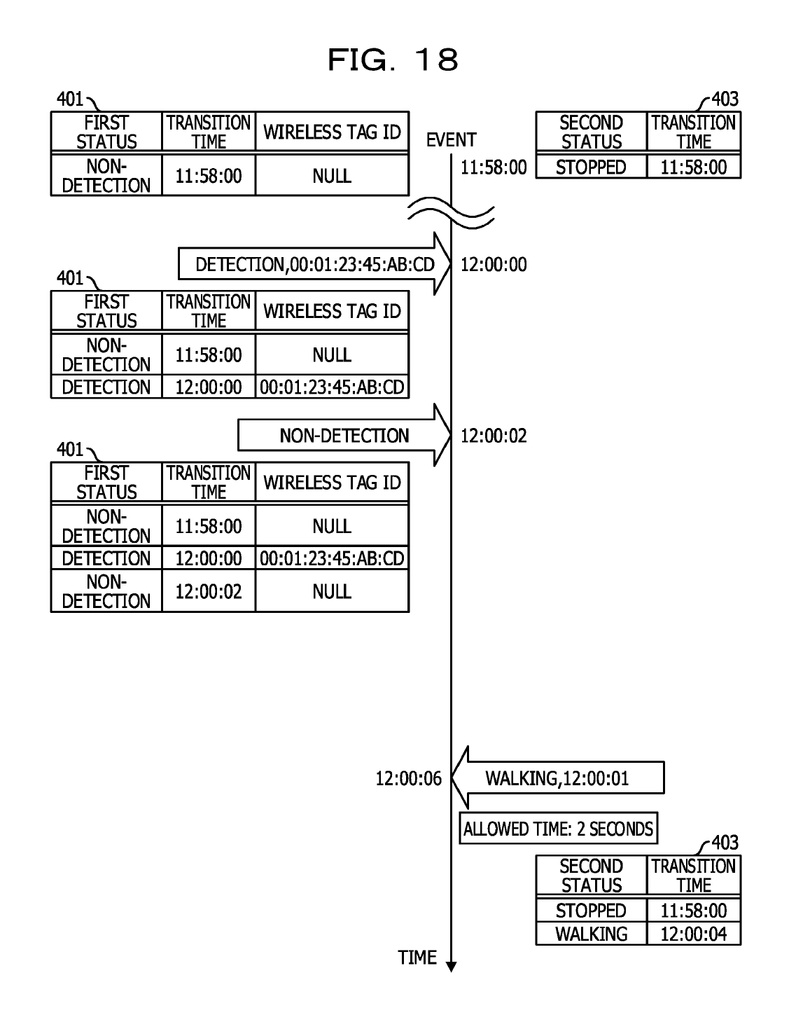

FIG. 18 illustrates an example of the table transition based on an example of FIG. 17. The first table 401 and the second table 403 from a time 11:58:00 to a time 12:00:02 are similar to the case of FIG. 4.

A “walking” event relating to the second status is generated at time 12:00:06. A time where the walking starts, that is, a transition time “12:00:01” is included in the “walking” event relating to the second status. At this time, the second record is provided in the second table 403. “Walking” based on an event is set in a field of the second status of the second record. A transition time “12:00:01” included in the event is delayed and “12:00:04” is set in a field of the transition time of the second record.

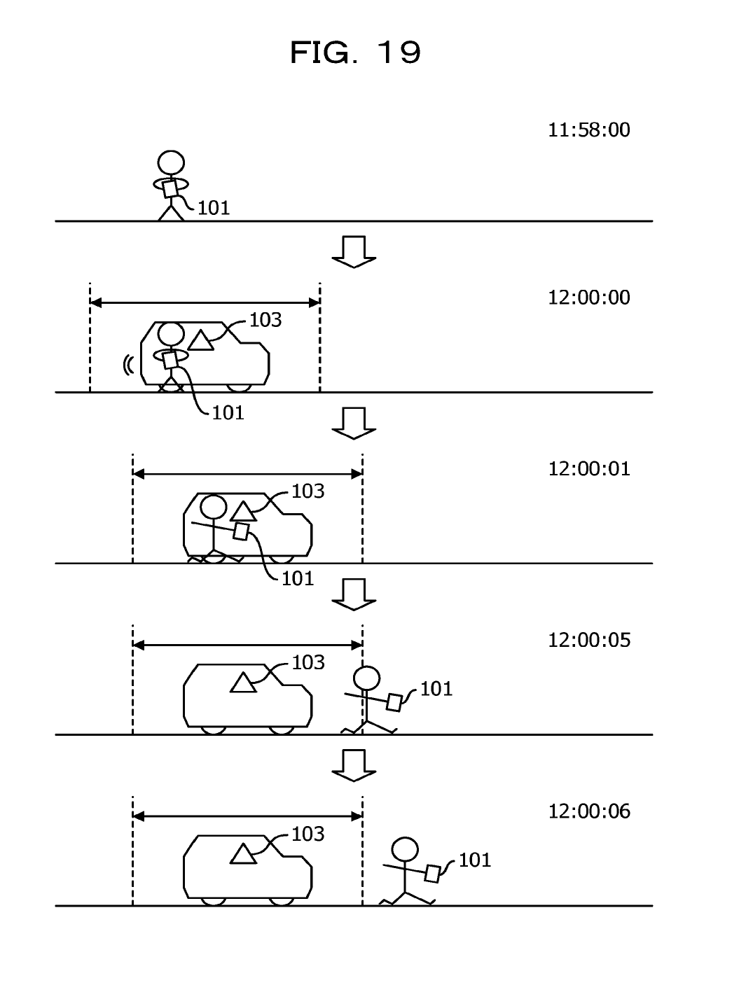

An example in which notification in the second embodiment is performed will be described. FIG. 19 illustrates another embodiment of the usage of the portable terminal 101. A case from a time 11:58:00 to a time 12:00:01 is the same as a case of FIG. 15. However, it is assumed that walking of the user is slow in this example.

Accordingly, at a time 12:00:05, the user goes out of the range in which the portable terminal 101 can detect the wireless tag 103. However, at this time, the portable terminal 101 does not yet detect the walking state.

At a time 12:00:06, the portable terminal 101 detects the walking state. At this time, the user is still remains in the vicinity of the taxi.

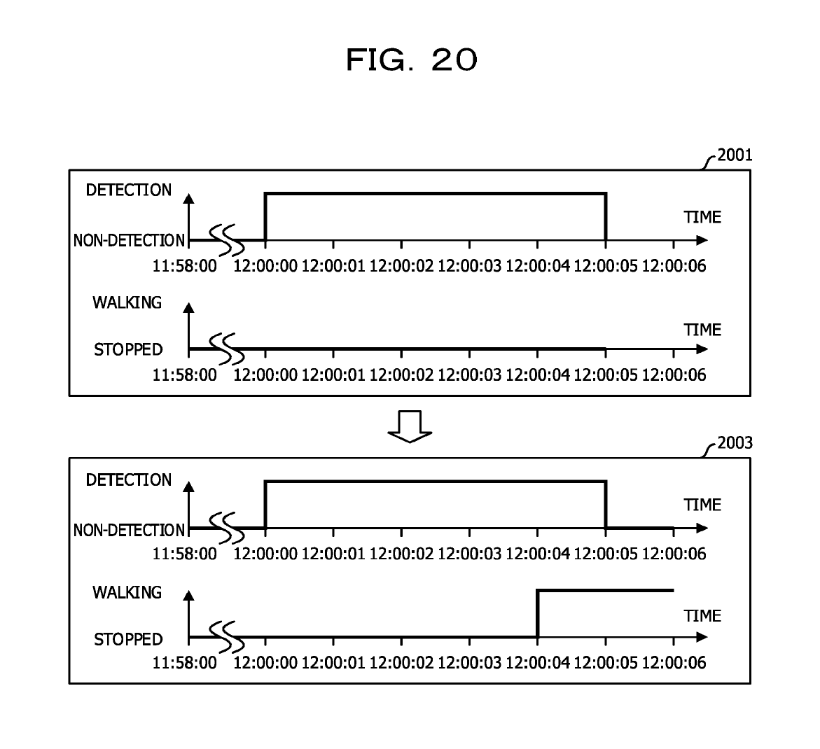

FIG. 20 illustrates an example of a status transition in which the portable terminal 101 is captured in an example of FIG. 19. A graph within a frame 2001 illustrates a status in which the portable terminal 101 is captured at a time 12:00:05. At this time, the second status still indicates “stopped”.

A graph within a frame 2003 illustrates a status in which the portable terminal 101 is captured at a time 12:00:06. The second status is changed to “walking” retroactively to a time 12:00:04.

As a result, a starting condition that the first status is “detection” and the second status is “walking” is satisfied from a time 12:00:04 to a time 12:00:05. Accordingly, the notification processing by application is performed at a time 12:00:06.

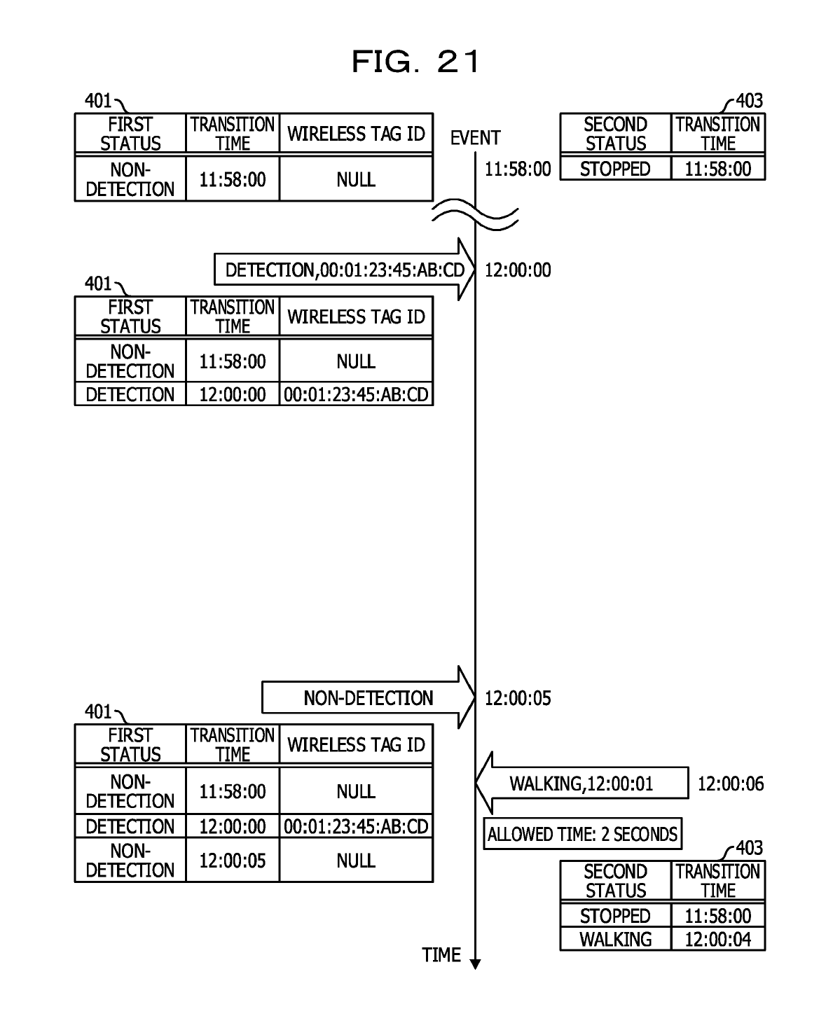

FIG. 21 illustrates an example of a table transition based on the example of FIG. 20. The first table 401 and the second table 403 at a time 11:58:00 to a time 12:00:00 are the same as that of a case of FIG. 4.

A “non-detection” event relating to the first status at a time 12:00:05 is generated. At this time, the third record is provided in the first table 401. “Non-detection” based on an event is set in a field of the first status of the third record. A time 12:00:05 at which the event is generated is set in a field of the transition time of the third record. NULL that means invalidity is set in a field of a wireless tag ID of the third record.

Accordingly, a “walking” event relating to the second status is generated at time 12:00:06. The second table 403 at a time 12:00:06 is the same as that of a case of FIG. 18. However, since a first status is “detection” in a delayed transition time “12:00:04”, it is determined that a starting condition is satisfied through a determination retroactive to a time 12:00:04. Hereinabove, the description of the embodiment described above is completed.

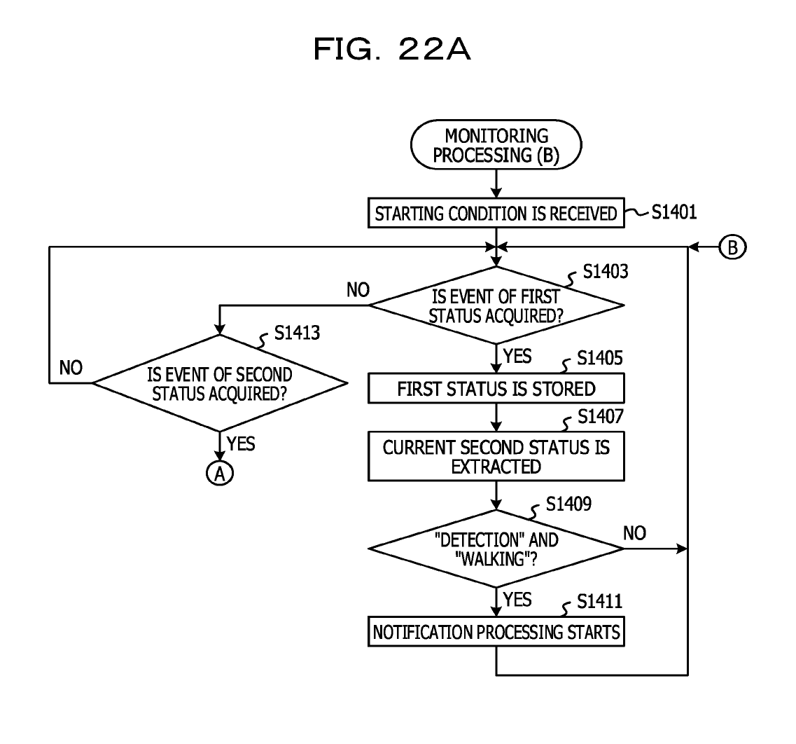

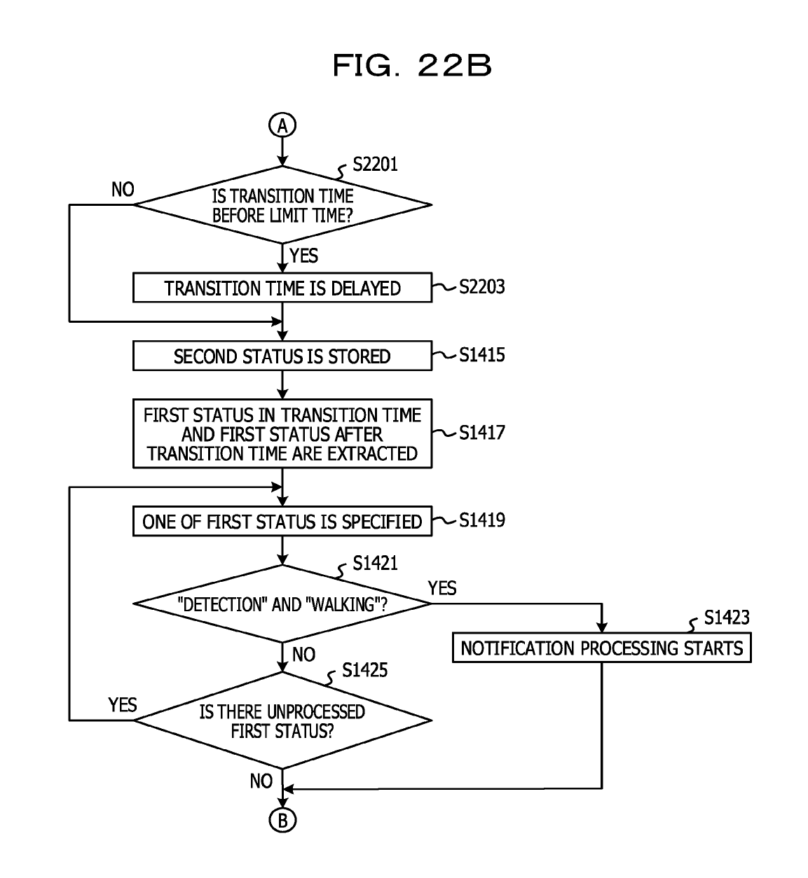

In the embodiment, the monitoring unit 605 performs the monitoring processing (B). FIG. 22A and FIG. 22B illustrate an example of a flow of the monitoring processing (B). In S1401, the reception unit 641 receives the above-described starting condition and the allowed time. Accordingly, the reception unit 641 stores the received allowed time in the condition storage unit 651.

Processing of S1403 to S1413 is the same as that of a case of FIG. 14.

In S1413, in a case where it is determined that an event relating to the transition of the second status from the first logic sensor 601 is acquired, the processing proceeds to processing of S2201 illustrated in FIG. 22B through a terminal A.

The description proceeds to description of FIG. 22B. The acquisition unit 643 determines whether or not a transition time included in an event relating to the transition time of the second status is a time before a limit time (S2201). The limit time is a time earlier than a time at which the event relating to the transition time of the second status in S1413 is acquired by an allowed time.

In a case where it is determined that the transition time precedes the limit time, the acquisition unit 643 transfers the transition time up to the limit time (S2203). That is, the processing of S1415 where it is considered that the limit time is the transition time, and subsequent processing are performed.

In a case where it is determined that the transition time does not precede the limit time, the processing proceeds to processing S1415.

Processing S1415 to S1425 is the same as that of a case of FIG. 14.

According to the embodiment, it is possible to omit unnecessary detection of a state in application embodiments with less meaning for monitoring a state retroactively to a time earlier than the present time by a long time.

### Third Embodiment

In this embodiment, a case where a sub-processor performs a part of processing in the first logic sensor 601, the second logic sensor 603, and the monitoring unit 605 will be described.

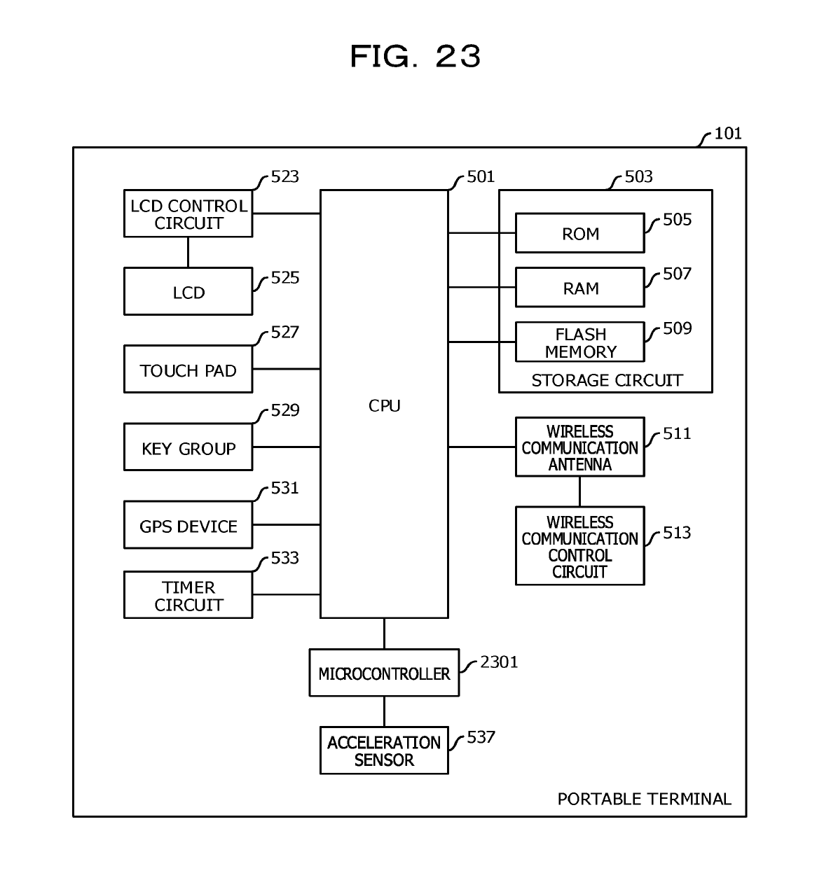

FIG. 23 illustrates an example of a hardware configuration of the portable terminal 101. A microcontroller 2301 is connected to the CPU 501. The acceleration sensor 537 is connected to the microcontroller 2301. The microcontroller 2301 controls the acceleration sensor 537.

In this example, the CPU 501 may acquire a measurement result of an acceleration sensor 537 through the microcontroller 2301.

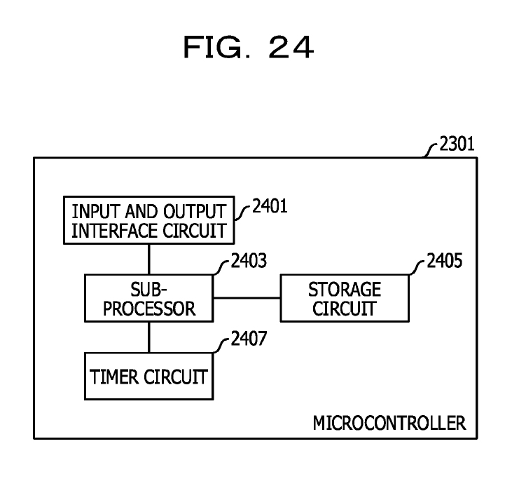

FIG. 24 illustrates an example of a hardware configuration of the microcontroller 2301. The microcontroller 2301 includes an input and output interface circuit 2401, a sub-processor 2403, a storage circuit 2405, and a timer circuit 2407.

The input and output interface circuit 2401 outputs a measurement instruction to the acceleration sensor 537. In addition, the input and output interface circuit 2401 receives measured posture data from acceleration data measured in the acceleration sensor 537. Furthermore, the input and output interface circuit 2401 sends data (for example, instruction and events) to the CPU 501, and receives data (for example, instruction and events) from the CPU 501.

The input and output interface circuit 2401 is connected to the sub-processor 2403. The sub-processor 2403 is connected to the storage circuit 2405 and the timer circuit 2407. The sub-processor 2403 performs calculation processing. The storage circuit 2405 stores data. The storage circuit 2405 includes, for example, a volatile memory and a non-volatile memory. The timer circuit 2407 measures time and elapsed time.

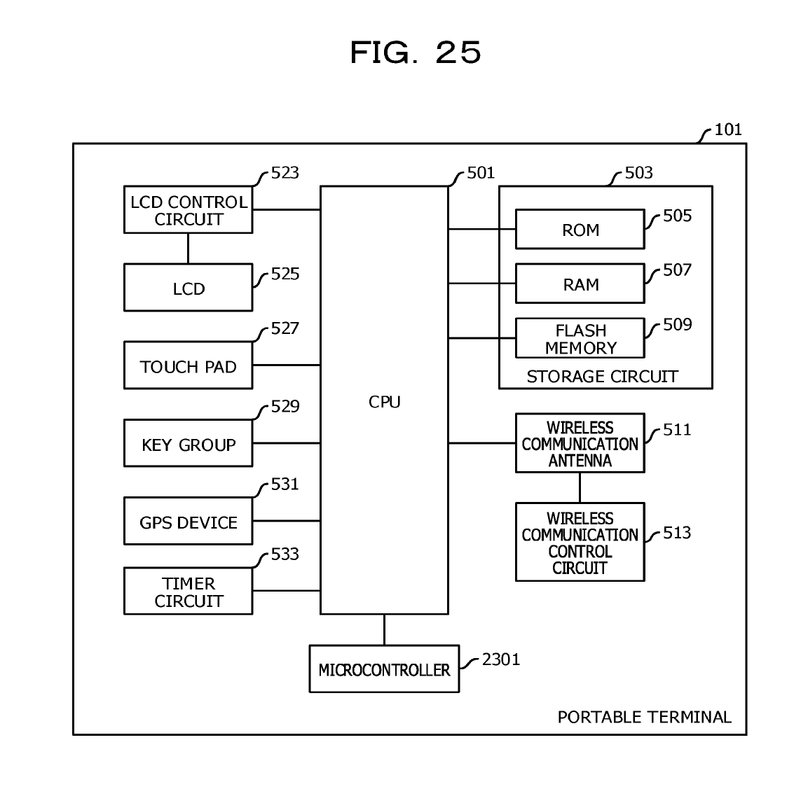

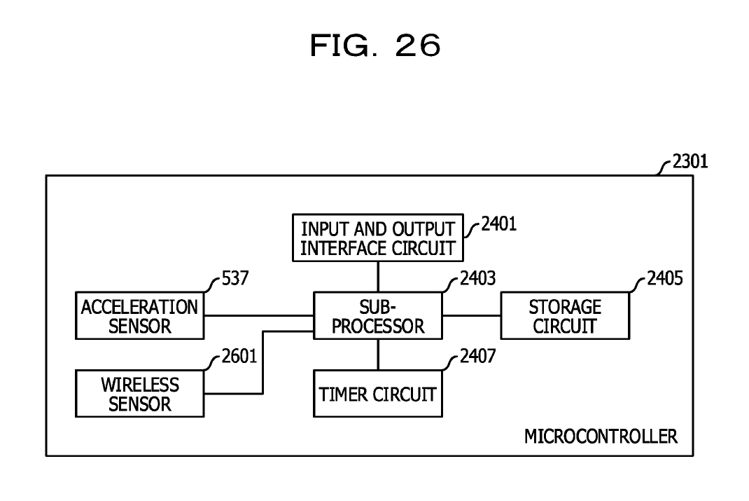

Furthermore, the acceleration sensor 537 may be included in the microcontroller 2301. An example of a hardware configuration of the portable terminal 101 in a case where the acceleration sensor 537 is included in the microcontroller 2301 is illustrated in FIG. 25. Furthermore, an example of a hardware configuration of the microcontroller 2301 including the acceleration sensor 537 is illustrated in FIG. 26. The acceleration sensor 537 is connected to the sub-processor 2403. The sub-processor 2403 sends the measurement instruction to the acceleration sensor 537. In addition, the sub-processor 2403 receives measured posture data from acceleration data measured in the acceleration sensor 537.

The microcontroller 2301 may include another sensor. For example, the microcontroller 2301 may include a wireless sensor 2601 for detecting the wireless tag 103. The wireless sensor 2601, for example, corresponds to the wireless communication antenna 511 and the wireless communication control circuit 513 illustrated in FIG. 5.

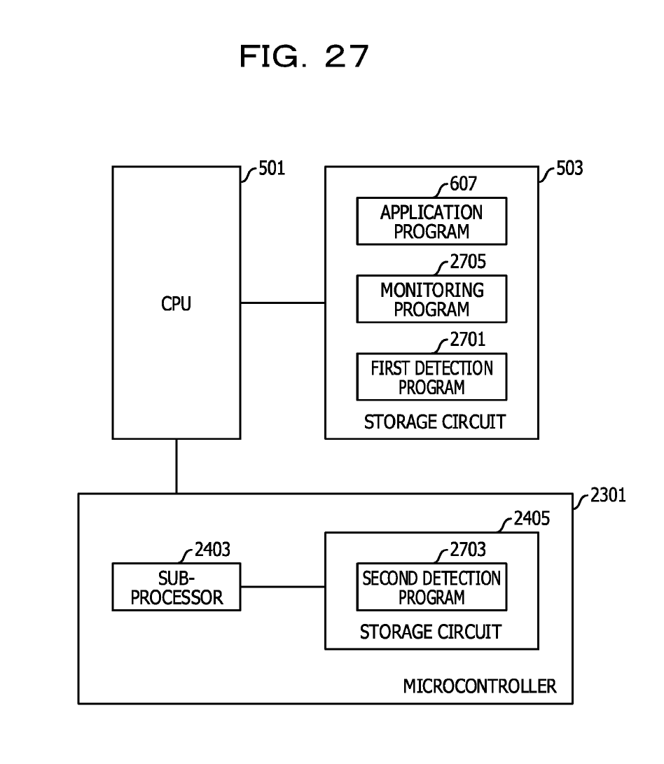

Then, three examples with respect to program allocation will be described. FIG. 27 illustrates an example of first program allocation. A first detection program 2701 for performing the first detection processing illustrated in FIG. 7 in the CPU 501 is stored in the storage circuit 503. The CPU 501 executes the first detection program 2701 such that the first logic sensor 601 is realized. Furthermore, the first status storage unit 615 is provided in the storage circuit 503.

A second detection program 2703 for executing the measurement processing illustrated in FIG. 8 and the second detection processing illustrated, for example, in FIG. 9 in the sub-processor 2403 is stored in the storage circuit 2405. The sub-processor 2403 executes the second detection program 2703 such that the second logic sensor 603 is realized. Furthermore, the second status storage unit 629 and the data storage unit 631 are provided in the storage circuit 2405. In addition, an event relating to transition of the second status is transferred from the input and output interface circuit 2401 to the CPU 501.

For example, a monitoring program 2705 for executing the monitoring processing illustrated in FIG. 14 in the CPU 501 is stored in the storage circuit 503. The CPU 501 executes the monitoring program 2705 so that the monitoring unit 605 is realized. Furthermore, the condition storage unit 651 and the table storage unit 653 are stored in the storage circuit 503.

The application program 607 is stored in the storage circuit 503. Accordingly, the CPU 501 executes the application program 607.

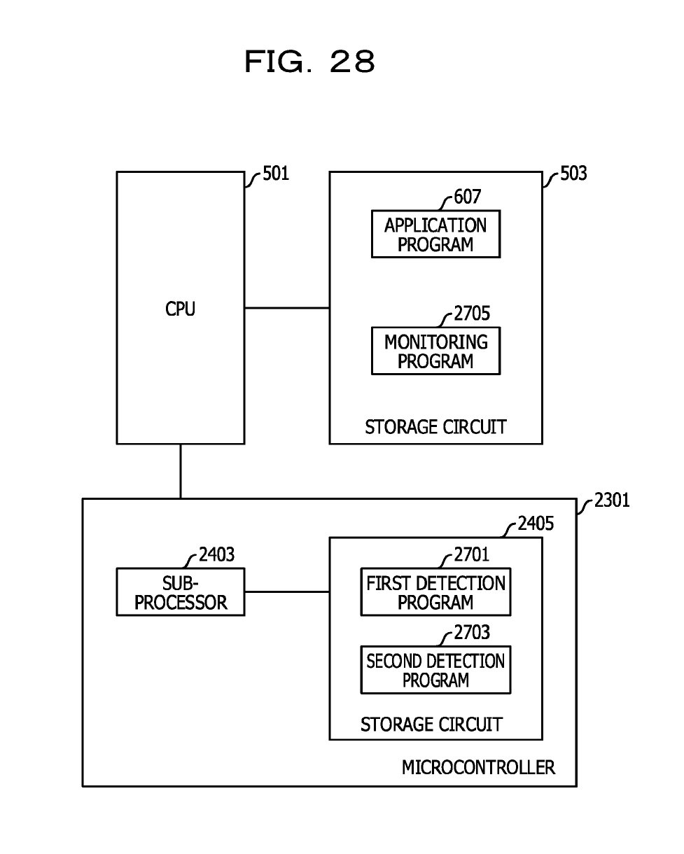

FIG. 28 illustrates an example of second program allocation. The first detection program 2701 for executing the first detection processing illustrated in FIG. 7 in the sub-processor 2403 is stored in the storage circuit 2405. The sub-processor 2403 executes the first detection program 2701 such that the first logic sensor 601 is realized. Furthermore, the first status storage unit 615 is provided in the storage circuit 2405. An event relating to transition of the first status is transferred from the input and output interface circuit 2401 to the CPU 501.

A second detection program 2703 for executing the measurement processing illustrated in FIG. 8 and the second detection processing illustrated, for example, in FIG. 9 in the sub-processor 2403 is stored in the storage circuit 2405. The sub-processor 2403 executes the second detection program 2703 such that the second logic sensor 603 is realized. Furthermore, the second status storage unit 629 and the data storage unit 631 are provided in the storage circuit 2405. In addition, an event relating to transition of the second status is transferred from the input and output interface circuit 2401 to the CPU 501.

For example, the monitoring program 2705 for executing the monitoring processing illustrated in FIG. 14 in the CPU 501 is stored in the storage circuit 503. The CPU 501 executes the monitoring program 2705 so that the monitoring unit 605 is realized. Furthermore, the condition storage unit 651 and the table storage unit 653 are stored in the storage circuit 503.

The application program 607 is stored in the storage circuit 503. Accordingly, the CPU 501 executes the application program 607.

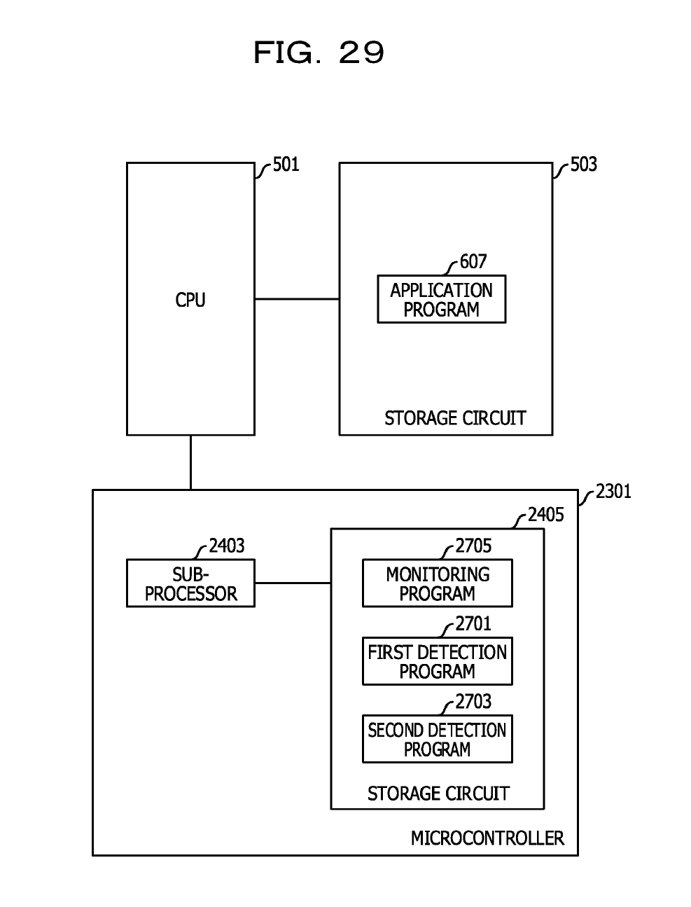

FIG. 29 illustrates an example of third program allocation. The first detection program 2701 for executing the first detection processing illustrated in FIG. 7 in the sub-processor 2403 is stored in the storage circuit 2405. The sub-processor 2403 executes the first detection program 2701 so that the first logic sensor 601 is realized. Furthermore, the first status storage unit 615 is provided in the storage circuit 2405.

The second detection program 2703 for executing the measurement processing illustrated in FIG. 8 and the second detection processing illustrated, for example, in FIG. 9 in the sub-processor 2403 is stored in the storage circuit 2405. The sub-processor 2403 executes the second detection program 2703 such that the second logic sensor 603 is realized. Furthermore, the second status storage unit 629 and the data storage unit 631 are provided in the storage circuit 2405.

For example, the monitoring program 2705 for executing the monitoring processing illustrated in FIG. 14 in the sub-processor 2403 is stored in the storage circuit 2405. The sub-processor 2403 executes the monitoring program 2705 such that the monitoring unit 605 is realized. Furthermore, the condition storage unit 651 and the table storage unit 653 are provided in the storage circuit 2405. The input and output interface circuit 2401 receives a starting condition (including allowed time when based on the second embodiment) sent from the CPU 501. In addition, the sub-processor 2403 starts a predetermined processing (in this example, notification processing) in the application program 607 through the input and output interface circuit 2401.

The application program 607 is stored in the storage circuit 503. Accordingly, the CPU 501 executes the application program 607.

In an example of program allocation illustrated in FIG. 28 and FIG. 29, the first logic sensor 601 may use the wireless sensor 2601 illustrated in FIG. 26.

According to the embodiment, it is possible to reduce the processing load of the CPU 501.

### Fourth Embodiment

In this embodiment, an example of a state monitoring system using the portable terminal 101 and a wearable terminal 3001 will be described. The wearable terminal 3001 processes a part of functions of the portable terminal 101 described above.

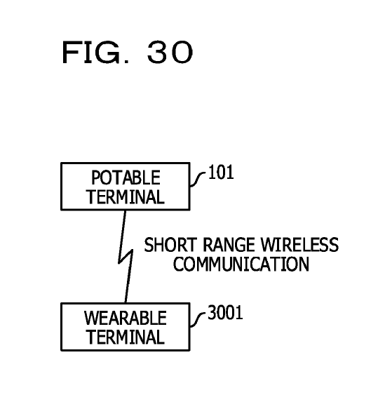

FIG. 30 illustrates an example of a configuration of a state monitoring system. The state monitoring system according to the embodiment includes the portable terminal 101 and the wearable terminal 3001. The portable terminal 101 and the wearable terminal 3001 perform short range wireless communication. The hardware configuration of the wearable terminal 3001 is the same as that of a case of, for example, FIG. 5.

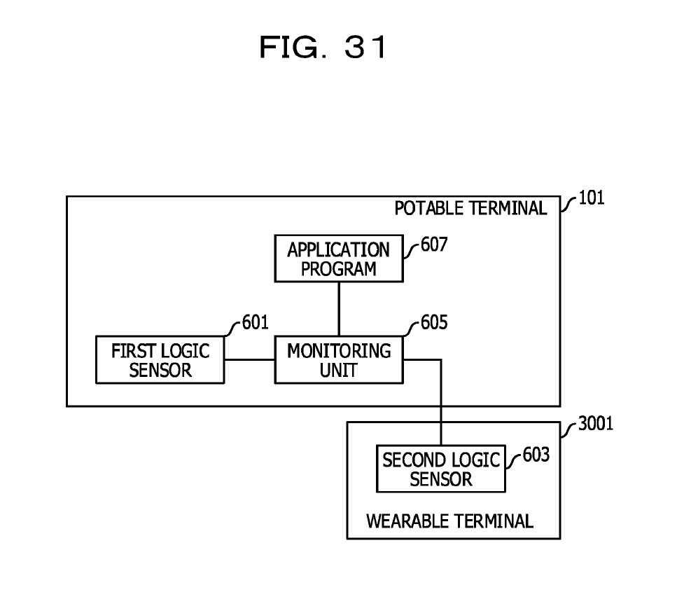

FIG. 31 illustrates an example of first module arrangement. The first logic sensor 601, the monitoring unit 605, and the application program 607 are provided in the portable terminal 101. The second logic sensor 603 is provided in the wearable terminal 3001. The portable terminal 101 receives an event relating to transition of the second status from the wearable terminal 3001 by short range wireless communication.

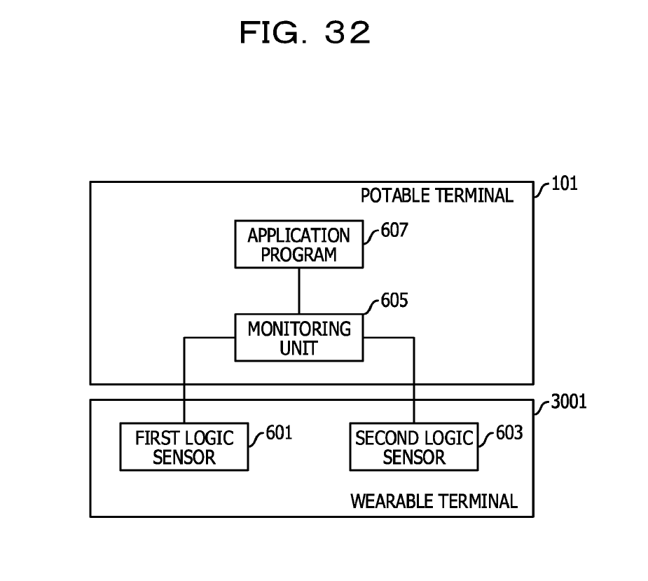

FIG. 32 illustrates an example of second module arrangement. The monitoring unit 605 and the application program 607 are provided in the portable terminal 101. The first logic sensor 601 and the second logic sensor 603 are provided in the wearable terminal 3001. The portable terminal 101 receives an event relating to transition of the first status and an event relating to transition of the second status from the wearable terminal 3001 by the short range wireless communication.

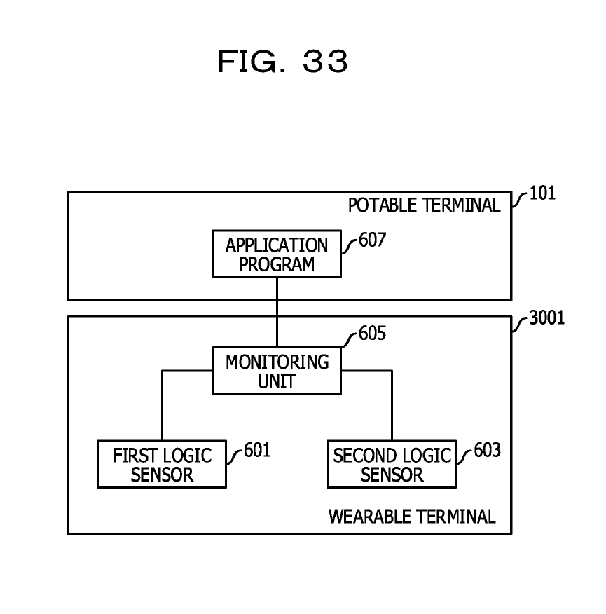

FIG. 33 illustrates an example of third module arrangement. The application program 607 is provided in the portable terminal 101. The first logic sensor 601, the second logic sensor 603, and the monitoring unit 605 are provided in the wearable terminal 3001. The wearable terminal 3001 receives a starting condition (including allowed time when based on second embodiment) from the portable terminal 101 by the short range wireless communication. In addition, the wearable terminal 3001 starts predetermined processing in the application program 607 by the short range wireless communication.

According to the embodiment, it is possible to monitor the state of the user by using the wearable terminal 3001. In addition, it is also possible to reduce the processing load of the portable terminal 101.

### Fifth Embodiment

In this embodiment, an example of a state monitoring system using the portable terminal 101 and a server device 3401 will be described. The server device 3401 processes a part of functions of the portable terminal 101 described above.

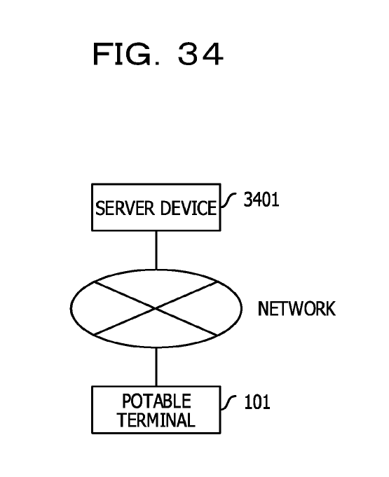

FIG. 34 illustrates an example of a configuration of a state monitoring system. The state monitoring system according to the embodiment includes the server device 3401 and the portable terminal 101. The server device 3401 and the portable terminal 101 communicate with each other through a network (for example, the internet or LAN).

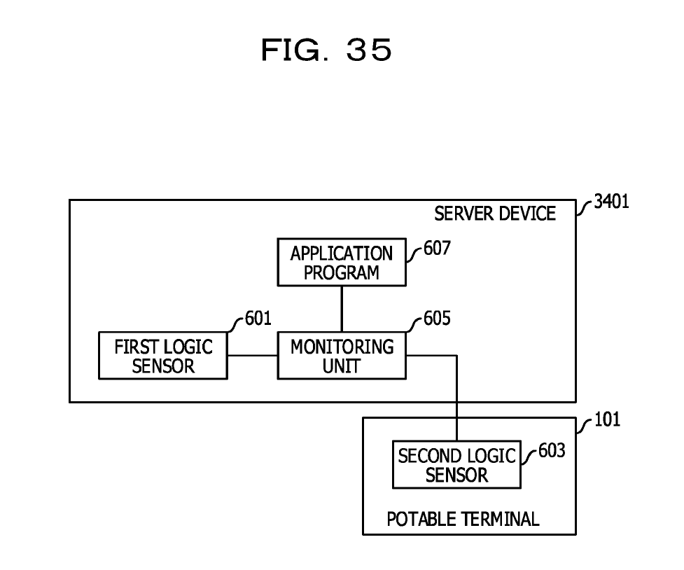

FIG. 35 illustrates an example of fourth module arrangement. The first logic sensor 601, the monitoring unit 605, and the application program 607 are provided in the server device 3401. The second logic sensor 603 is provided in the portable terminal 101. The server device 3401 receives an event relating to transition of the second status from the portable terminal 101 through the network.

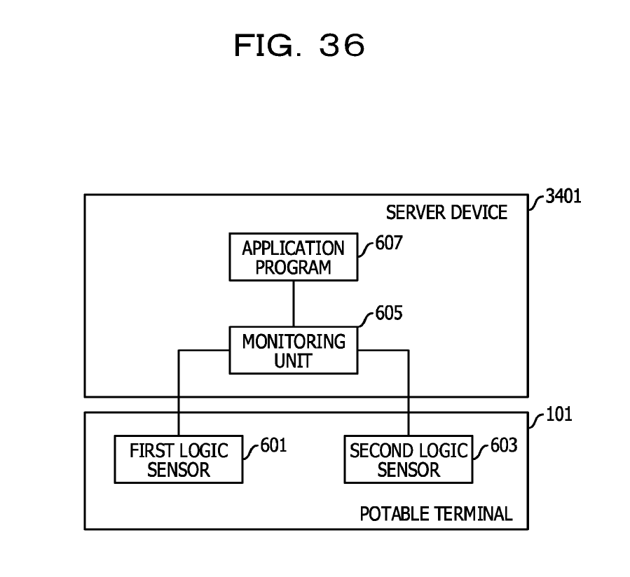

FIG. 36 illustrates an example of fifth module arrangement. The monitoring unit 605 and the application program 607 are provided in the server device 3401. The first logic sensor 601 and the second logic sensor 603 are provided in the portable terminal 101. The server device 3401 receives an event relating to transition of the first status and an event relating to transition of the second status from the portable terminal 101 through the network.

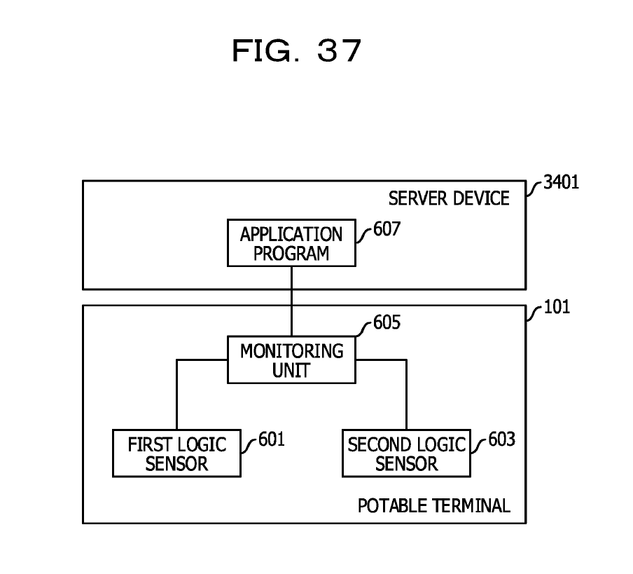

FIG. 37 illustrates an example of sixth module arrangement. The application program 607 is provided in the server device 3401. The first logic sensor 601, the second logic sensor 603, and the monitoring unit 605 are provided in the portable terminal 101. The portable terminal 101 receives a starting condition (including allowed time when based on second embodiment) from the server device 3401 through the network. In addition, the portable terminal 101 starts a predetermined processing in the application program 607 through the network.

According to the embodiment, it is possible to perform state monitoring by using the network. In addition, it is possible to reduce the processing load of the portable terminal 101.

### Sixth Embodiment

An example of another second logic sensor 603 will be described. In the above-described embodiment, an example in which the walking state of the user is described in the second logic sensor 603 is described. However, in the embodiment, an example in which the current position of the user is detected in the second logic sensor 603 will be described.

The second logic sensor 603 according to the embodiment measures the current position of the portable terminal 101 by using the GPS device 531. The second status according to the embodiment indicates accuracy of the measurement. Specifically, the second status indicates one of “high accuracy” and “low accuracy”. In a case where the second status is “high accuracy”, reliability of the measured current position is high. In a case where the second status is “low accuracy”, the reliability of the measured current position is low.

The application program 607 according to the embodiment performs a service using a current position in a case where the second status is “high accuracy”. In this example, the application program 607 performs provision of information to help the search for a stolen vehicle. The stolen vehicle has the wireless tag 103 mounted thereon. A starting condition in the monitoring unit 605 is that the first status is “detection” and the second status is “high accuracy”. When the starting condition is satisfied, an ID of the wireless tag 103 for specifying the stolen vehicle and information about a current position indicating an address of the stolen vehicle help the search for the stolen vehicle. Accordingly, the application program 607 notifies a server that supports the search for the stolen vehicle of the ID of the wireless tag 103 and the current position of the portable terminal 101.

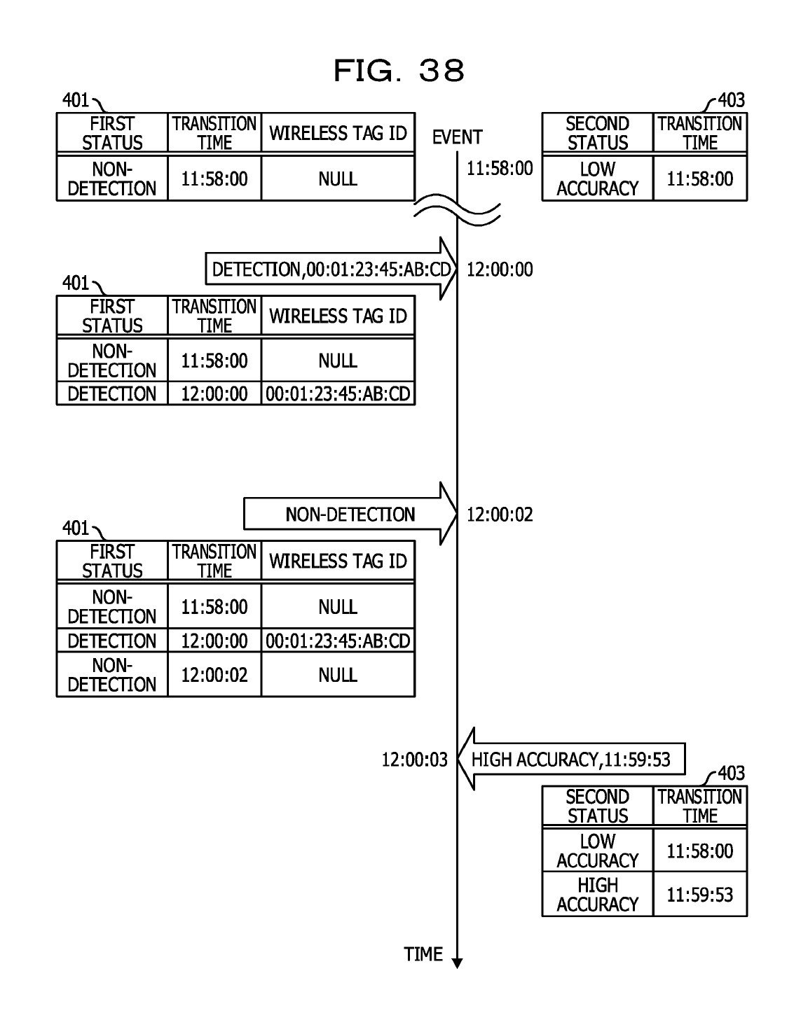

FIG. 38 illustrates an example of a table transition in the embodiment. A configuration of the first table 401 is the same as that of a case of FIG. 4.

Similar to the case of FIG. 4, the record of the second table 403 includes a field for setting the second status, and a field for setting the transition time of the second status. However, the second status indicates one of “high accuracy” and “low accuracy”.

In a case where the second status is “high accuracy”, a time earlier than a time at which “high accuracy” measurement is performed by a predetermined time, is set in the record as a transition time.

When considering the accuracy of walking speed of the user and position measurement, there is a case in which the current position may be considered to be effective even before a measurement time. Accordingly, in the embodiment, a time earlier than the measurement time by a predetermined time is processed as the transition time. That is, the predetermined time corresponds to a period that is considered that the user is present in the vicinity of current location. The predetermined time may be determined in advance in consideration of, for example, the walking speed of the user. It is assumed that the user is present in the vicinity for a relatively long time when walking of the user is slow. On the other hand, when the walking speed of the user is fast, it is assumed that the user is only in the vicinity for a relatively short time.

In a case where the second status is “low accuracy”, a time at which “low accuracy” measurement is performed is set in the record as the transition time.

In an example illustrated in FIG. 38, the first record is provided in the first table 401 at a time 11:58:00 at which an application starts. An initial value “non-detection” is set in a field of the first status of the first record. A starting time 11:58:00 is set in a field of a transition time of the first record. In addition, NULL that means invalidity is set in a field of the wireless tag ID of the first record.

In addition, the first record is provided in the second table 403 at a time 11:58:00 at which application starts. An initial value “low accuracy” is set in a field of the second status of the first record. A starting time 11:58:00 is set in a field of a transition of the first record.

Accordingly, the stolen vehicle is stopped in the vicinity of the user at a time 12:00:00, and a “detection” event relating to the first status is generated. An ID of the detected wireless tag 103 is included in the “detection” event relating to the first status. At this time, the second record is provided in the first table 401. “Detection” is set in a field of the first status of the second record based on an event. A time 12:00:00 at which an event is generated is set in a field of a transition time of the second record. In addition, a wireless tag ID “00:01:23:45:AB:CD” included in the “detection” event relating to the first status is set in a field of the wireless tag ID of the second record.

However, in the determination at a time 12:00:00 at which the “detection” event relating to the first status is generated, since the current second status is “low accuracy”, a starting condition is not satisfied. Accordingly, the notification processing is not performed.

Next, a “non-detection” event relating to the first status is generated so as to detect out of a range in which the portable terminal 101 can detect the wireless tag 103 according to movement of the user at a time 12:00:02. At this time, the third record is provided in the first table 401. The “non-detection” based on an event is set in a field of the first status of the third record. A time 12:00:02, at which an event is generated, is set in a field of transition time of the third record. NULL that means invalidity is set in a field of the wireless tag ID of the third record.

In the determination at a time 12:00:02 at which the “non-detection” event relating to the first status is generated, since the current first status is “non-detection”, and additionally the current second status is “low accuracy”, a starting condition is not satisfied. Accordingly, the notification processing is not performed.

Next, a reception state of radio waves is improved, for example, in a GPS device 531 at a time 12:00: 03, and an event (hereinafter, referred to as “high accuracy” event) indicating that the second status is transferred to “high accuracy” is generated. A time earlier than a time at which the “high accuracy” event is performed by a predetermined time (in this example, 10 seconds), that is, a transition time “11:59:53” is included in the “high accuracy” event relating to the second status. Accordingly, the second record is provided in the second table 403. The “high accuracy” based on an event is set in a field of the second status of the second record. A transition time “11:59:53” included in the “high accuracy” event relating to the second status is set in a field of a transition time of the second record.

In the determination at a time 12:00:03 at which the “high accuracy” event relating to the second status is generated, since the first status is “detection” and the second status is “high accuracy” during from a time 12:00:00 to a time 12:00:02, a starting condition is satisfied. Accordingly, the notification processing is performed.

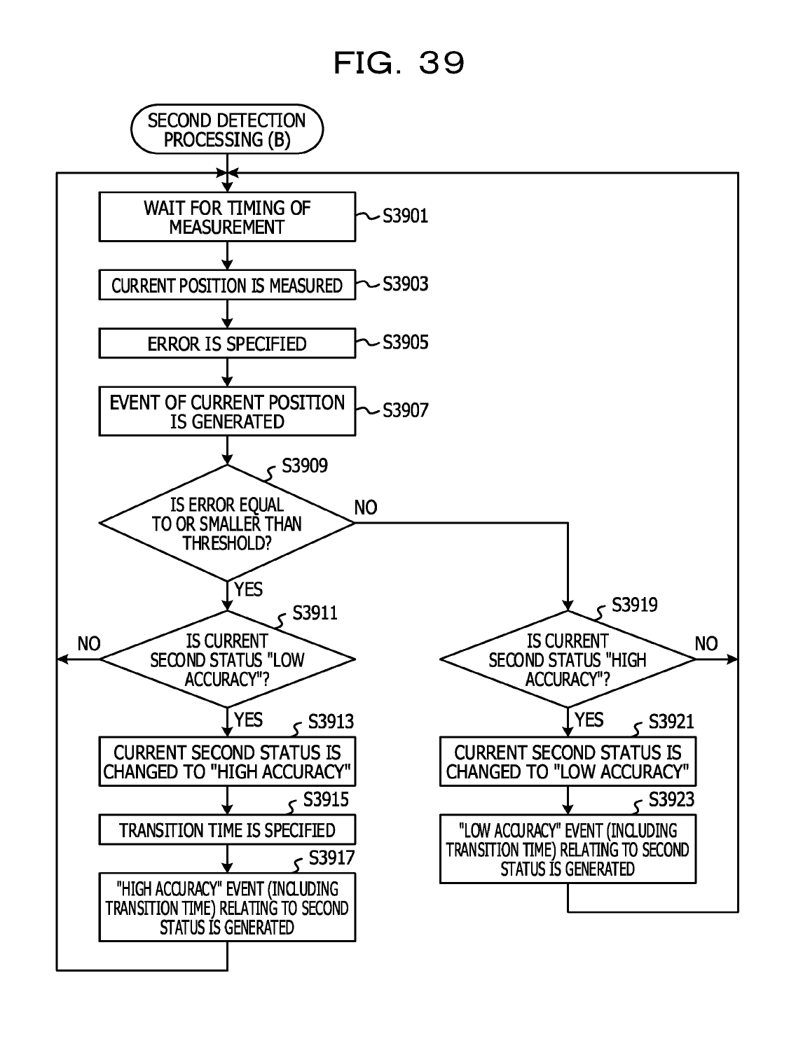

Next, the second detection processing will be described in the embodiment. In the embodiment, the second detection processing (B) will be described. FIG. 39 illustrates an example of a second detection processing (B) flow. The measurement unit 621 waits for a timing for measuring the current position (S3901). In this example, the first determination unit 623 measures the current position during a predetermined period using the GPS device 531.

When the processing reaches a timing for measuring the current position, the measurement unit 621 measures the current position (S3903). The current position is represented by geographic coordinates (latitude and longitude). Data of the current position is stored with a measurement time in the data storage unit 631.

The measurement unit 621 specifies an error of measurement (S3905). The error of measurement is represented by a distance.

The second generation unit 627 generates a measurement event of the current position (S3907). In this example, the measurement event of the current position is transferred to the application program 607. The monitoring unit 605 does not acquire the measurement event of the current position.

The first determination unit 623 determines whether or not the error is equal to or smaller than a threshold (for example, 20 m) (S3909). When the error is equal to or smaller than a threshold, it is considered that current position is measured with high accuracy. When the error exceeds the threshold, it is considered that current position is measured with low accuracy.

In a case where it is determined that the error is equal to or smaller than the threshold, the first determination unit 623 determines whether or not the current second status stored in a second status storage unit 629 is “low accuracy” (S3911).

In a case where it is determined that current second status stored in the second status storage unit 629 is not “low accuracy”, that is, in a case where the current second status is “high accuracy”, the second status is not changed. Accordingly, the processing returns to processing of S3901, and the above-described processing is repeated.

In a case where it is determined that current second status stored in a second status storage unit 629 is “low accuracy”, the first determination unit 623 changes the current second status to “high accuracy” (S3913).

Accordingly, the specification unit 625 specifies the transition time (S3915). In this example, the specification unit 625 considers a time earlier than a time at which the current position is measured in S3903 by a predetermined time, as a transition time. The predetermined time may be determined in advance. Alternatively, the application program 607 may designate the predetermined time.

The second generation unit 627 generates a “high accuracy” event relating to the second status (S3917). The transition time specified in S3915 is included in the “high accuracy” event relating to the second status. The “high accuracy” event relating to the second status is transferred to the monitoring unit 605. Accordingly, the processing returns to processing of S3901, and the above-described processing is repeated.

The description returns to the determination in S3909. In a case where it is determined that the error is not equal to or smaller than the threshold, that is, in a case where the error exceeds the threshold, the first determination unit 623 determines whether or not the current second status stored in the second status storage unit 629 is “high accuracy” (S3919).

In a case where it is determined that the current second status stored in the second status storage unit 629 is not “high accuracy”, that is, in a case where the current second status is “low accuracy”, the second status is not changed. Accordingly, the processing returns to processing of S3901, and the above-described processing is repeated.

Meanwhile, in a case where it is determined that the current second status stored in the second status storage unit 629 is “high accuracy”, the first determination unit 623 changes the current second status to “low accuracy” (S3921).

The second generation unit 627 generates an event (hereinafter, referred to as “low accuracy” event) indicating that the second status is transferred to “low accuracy” (S3923). The transition time in the “low accuracy” event relating to the second status indicates a time at which the current position is measured in S3903. Accordingly, the processing returns to processing of S3901, and the above-described processing is repeated.

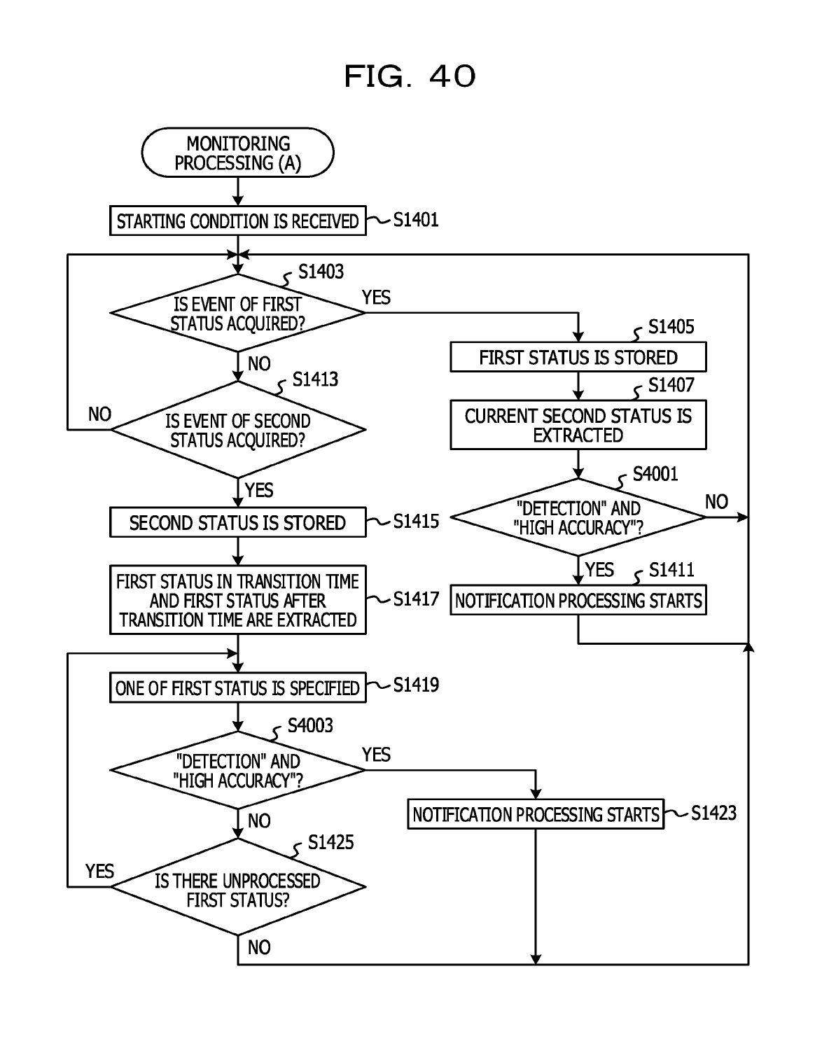

Next, the monitoring processing will be described in the embodiment. In the embodiment, the monitoring processing (C) is performed. FIG. 40 illustrates an example of a monitoring processing (C) flow. In this example, the starting condition received in S1401 is set that the first status is “detection” and the second status is “high accuracy”.

The processing of S1403 to S1407 is the same as that of a case of FIG. 14.

The second determination unit 647 in S4001 determines whether or not the first status of the event acquired in S1403 is “detection” and the current second status is “high accuracy”. In a case where it is determined that the first status of the event acquired in S1403 is “detection” and the current second status is “high accuracy”, the processing proceeds to processing of S1411. Meanwhile, in a case where it is determined that the condition is not satisfied, the processing returns to processing of S1403, and the above-described processing is repeated.

In the notification processing started in S1411, the application program 607 acquires a measurement event of the current position from the second logic sensor 603. Accordingly, the application program 607 notifies the server which supports the search of the stolen vehicle that the wireless tag ID is detected in the current position of the portable terminal 101.

The server which supports the search of the stolen vehicle notifies, for example, the owner of the stolen vehicle of the location of the stolen vehicle. In this manner, information that becomes a clue to search the stolen vehicle is provided.

The processing of S1413 to S1419 is the same as that of a case of FIG. 14.

The second determination unit 647 in S4003 determines whether or not the first status of the event specified in S1419 is “detection” and the current second status indicated by the event acquired in S1413 is “high accuracy”. In a case where it is determined that the first status of the event specified in S1419 is “detection” and the second status indicated by the event acquired in S1413 is “high accuracy”, the processing proceeds to processing represented in S1423. Meanwhile, in a case where it is determined that the condition is not satisfied, the processing proceeds to processing represented in S1425.

The processing of S1423 to S1425 is the same as that of a case of FIG. 14.

According to the embodiment, status monitoring is performed based on position information with high reliability. In this example, it is possible to correctly capture a status that the stolen vehicle is in the vicinity.

In each embodiment described above, the wireless tag 103 of a detection target may be limited in the starting condition. Accordingly, the monitoring unit 605 may ignore the wireless tags 103 other than the wireless tag 103 which is determined in the starting condition.

In S1407, the extraction unit 645 may delete a record before a record of the current second status. Furthermore, the extraction unit 645 may delete a record before a record of the first status that is extracted, in S1417. In this manner, the waste of the storage area is not generated.

Although, embodiments of the disclosure are described above, the disclosure is not limited thereto. For example, there is a case where the above-described function block configuration does not match a program module configuration.

In addition, a configuration of each of the storage areas described above is only an example and does not indicate that the configuration as described above has to be used. Furthermore, also in the processing flow, if the result of the processing is not changed, an order of the processing may be changed and a plurality of processing may be run in parallel.

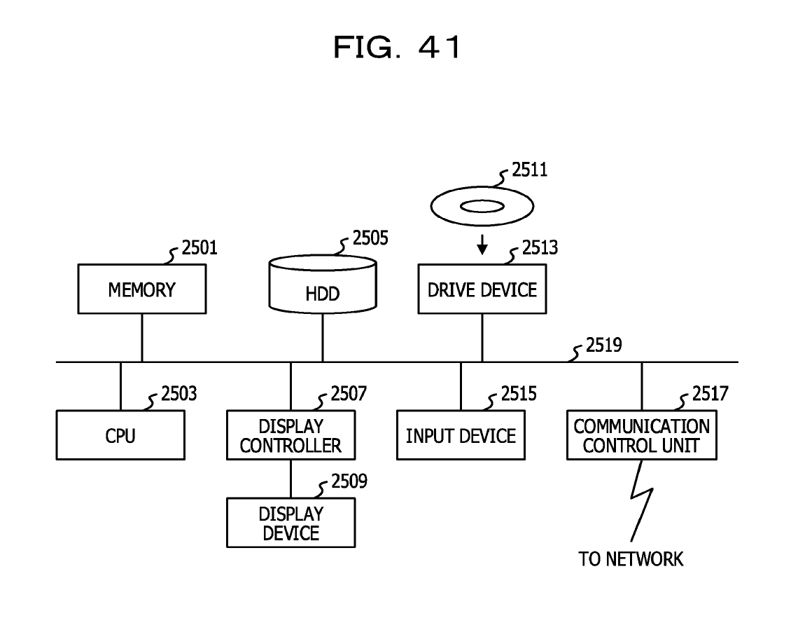

In addition, the above-described server device 3401 is a computer device. As illustrated in FIG. 41, a memory 2501, a central processing unit (CPU) 2503, a hard disk drive (HDD) 2505, a display controller 2507 connected to a display device 2509, a drive device 2513 for a removable disk 2511, an input device 2515, and a communication control unit 2517 for connecting a network, are connected to a bus 2519. An operating system (OS) and application programs for performing processing in the embodiment are stored in the HDD 2505, read from the HDD 2505, and written in the memory 2501, when executed by the CPU 2503. The CPU 2503 controls the display controller 2507, the communication control unit 2517, and the drive device 2513, and performs a predetermined operation according to processing contents of application programs. In addition, data in the processing is stored in the memory 2501. However, the data may be stored in the HDD 2505. In examples of the disclosure, the application program for executing the above-described processing is distributed by being stored in a computer readable removable disk 2511, and installed in the HDD 2505 from the drive device 2513. There is also a case where the application program is installed in the HDD 2505 through a network such as an internet and the communication control unit 2517. The above-described various functions are realized by the computer devices organically cooperating with hardware such as the CPU 2503 and the memory 2501, and programs such as OS and application programs, described above.

The embodiments described above are summarized as follows.

An aspect of the state monitoring method includes (A) processing that detects state transition in the first status, (B) processing that detects state transition in the second status, (C) specification processing that specifies a time point earlier than a first time point at which the state transition of the second status is detected as a second time point at which state transition of the second status occurs, and (D) determination processing that determines whether a condition according to a combination of the first status and the second status is satisfied at least at the second time point.

In this case, it is possible to correctly capture a state according to a combination of a plurality of statuses. Specifically, it is possible to correctly capture a state according to a combination of the other of statuses, even in a case where detection of one of the statuses is delayed.

Furthermore, in the above determination processing, whether the above condition is satisfied between a second time point and a first time point may be determined. In this case, it is possible to suppress missing of a state according to a combination of a plurality of status.

Furthermore, processing that limits a time interval between the second time point and the first time point may be included. In this case, in application embodiments with less meaning for monitoring a state retroactively to a time earlier than the present time by a long time, it is possible to reduce unnecessary detection of a state.

Furthermore, in the specification processing, the second time point may be specified based on change in the time-series data used in the detection of the transition of the second status. In this case, it is possible to correctly specify the second time point.

Furthermore, processing that starts a predetermined processing based on a determination result of the condition may be included. In this case, it is possible to perform a predetermined processing according to the state.

In addition, it is possible to create a program for performing the above-described processing in a processor or a computer. The program may be stored, for example, on a computer readable storage medium or a storage device such as, a flexible disk, a CD-ROM, a magneto optical disk, a semiconductor memory, a hard disk, and the like. Furthermore, intermediate processing results are generally temporarily stored in a storage device such as a main memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
acquire information of first status that represents a state of a first detection target detected by a first sensor;
specify state transition in which the first status is changed based on the acquired information of the first status;
acquire information of second status that represents a state of a second detection target detected by a second sensor;
specify state transition in which the second status is changed based on the acquired information of the second status;
specify a time point earlier than a first time point at which the state transition of the second status is specified as a second time point at which the state transition of the second status occurs;
determine whether or not a combination of the second status and the first status at least at the second time point satisfies a predetermined condition; and
perform predetermined processing according to a determination result indicating the condition is satisfied.

2. The information processing device according to claim 1, wherein
the processor is configured to determine whether the condition is satisfied between the second time point and the first time point.

3. The information processing device according to claim 1, wherein
a time interval between the second time point and the first time point is limited to a time equal to or less than a predetermined time.

4. The information processing device according to claim 1, wherein
the processor is configured to specify the second time point based on change in the time-series data used in the detecting of the state transition of the second status.

5. The information processing device according to claim 1, further comprising:
the first sensor; and
the second sensor.

6. The information processing device according to claim 5, wherein
the first sensor is configured to detect a wireless tag by receiving a wireless signal generated by a nearby device included in the first detection target.

7. The information processing device according to claim 5, wherein
the second sensor is configured to measure acceleration of the information processing device.

8. A method comprising:
acquiring, by a processor, information of first status that represents a state of a first detection target detected by a first sensor;
specifying, by the processor, state transition in which the first status is changed based on the acquired information of the first status;
acquiring, by the processor, information of second status that represents a state of a second detection target detected by a second sensor;
specifying, by the processor, state transition in which the second status is changed based on the acquired information of the second status;
specifying, by the processor, a time point earlier than a first time point at which the state transition of the second status is specified as a second time point at which the state transition of the second status occurs;
determining, by the processor, whether or not a combination of the second status and the first status at least at the second time point satisfies a predetermined condition; and
performing, by the processor, predetermined processing according to a determination result indicating the condition is satisfied.

9. The method according to claim 8,
wherein in the determining, whether the condition is satisfied between the second time point and the first time point is determined.

10. The method according to claim 8,
wherein a time interval between the second time point and the first time point is limited to a time equal to or less than a predetermined time.

11. The method according to claim 8,
wherein in the specifying of the second time point, the second time point is specified based on change in the time-series data used in the detecting of the state transition of the second status.

12. A non-transitory computer readable medium having stored therein a program that causes a computer to execute a process, the process comprising:
acquiring information of first status that represents a state of a first detection target detected by a first sensor;
specifying state transition in which the first status is changed based on the acquired information of the first status;
acquiring information of second status that represents a state of a second detection target detected by a second sensor;
specifying state transition in which the second status is changed based on the acquired information of the second status;
specifying a time point earlier than a first time point at which the state transition of the second status is specified as a second time point at which the state transition of the second status occurs;
determining whether or not a combination of the second status and the first status at least at the second time point satisfies a predetermined condition; and
performing predetermined processing according to a determination result indicating the condition is satisfied.

13. The non-transitory computer readable medium according to claim 12, wherein the process further comprising:
wherein in the determining, whether the condition is satisfied between the second time point and the first time point is determined.

14. The non-transitory computer readable medium according to claim 12, wherein the process further comprising:
wherein a time interval between the second time point and the first time point is limited to a time equal to or less than a predetermined time.

15. The non-transitory computer readable medium according to claim 12, wherein the process further comprising:
wherein in the specifying of the second time point, the second time point is specified based on change in the time-series data used in the detecting of the state transition of the second status.
